(19) United States
(12) Patent Application Publication
(10) Pub. No.: US 2005/0238870 A1
(43) Pub. Date: Oct. 27, 2005

(54) Embolization

(76) Inventors: Marcia Buiser, Watertown, MA (US); Paul DiCarlo, Middleboro, MA (US); Thomas V. Casey II, Grafton, MA (US); Erin McKenna, Boston, MA (US); Robert F. Rioux, Ashland, MA (US)

Correspondence Address: FISH & RICHARDSON PC, P.O. BOX 1022, MINNEAPOLIS, MN, 55440-1022, US

(21) Appl. No.: 10/830,195

(22) Filed: Apr. 22, 2004

(51) Int. Cl. B32B 5/16

(52) U.S. Cl. 428/323

(57) ABSTRACT

Embolization, as well as related compositions and methods, are disclosed.

### TECHNICAL FIELD

The invention relates to embolization, as well as related compositions and methods.

### BACKGROUND

Therapeutic vascular occlusions (embolizations) are used to prevent or treat pathological conditions in situ. Compositions including embolic particles are used for occluding vessels in a variety of medical applications. Delivery of embolic particles through a catheter is dependent on size uniformity, density and compressibility of the embolic particles.

### SUMMARY

In one aspect, the invention features a composition that includes a particle chain with at least two connected particles. At least one of the at least two connected particles has an interior region with a density of large pores and a surface region with a density of large pores. The density of large pores of the interior region is greater than the density of large pores at the surface region.

In another aspect, the invention features a method that includes forming a mixture containing a polymer and a gelling compound, and treating the mixture to form a particle chain that includes at least two connected particles. At least one of the at least two connected particles has an interior region with a density of large pores and a surface region with a density of large pores. The density of large pores of the interior region is greater than the density of large pores at the surface region.

In a further aspect, the invention features a method that includes forming a stream of a mixture containing a polymer and a gelling compound through a nozzle, and vibrating the nozzle at a vibration duty cycle of about 40/60 or lower (e.g., about 30/70, about 20/80).

In another aspect, the invention features a method that includes administering to a patient a therapeutically effective amount of a composition including a particle chain with at least two connected particles. At least one of the at least two connected particles has an interior region with a density of large pores and a surface region with a density of large pores. The density of large pores of the interior region is greater than the density of large pores at the surface region.

In an additional aspect, the invention features a method of forming a particle chain having at least two linked particles, the method including disposing a filament of material through at least two cavities in a mold, and forming the particles in the cavities so that the particles are linked by the filament to form the particle chain.

In a further aspect, the invention features a method of forming a particle chain having at least two linked particles, the method including forming the particles in at least two particle cavities in a mold, and forming a link between the particles in a link cavity in the mold that connects the particle cavities, to form the particle chain.

In another aspect, the invention features a composition that includes a particle chain having at least two adjacent particles that are connected by a filament. At least one of the particles includes a polymer that can change shape to change the length of the filament between the adjacent particles.

Embodiments may also include one or more of the following.

Each of the particles can have a diameter of from about ten microns to about 3,000 microns.

The particles can have an arithmetic mean diameter of about 3000 microns or less (e.g., about 1200 microns or less, about 500 microns or less) and/or about ten microns or more (e.g., about 500 microns or more).

The particle chain can have a restrained length of at most about 50 centimeters (e.g., at most about 25 centimeters, at most about 20 centimeters, at most about 15 centimeters, at most about ten centimeters, at most about five centimeters) and/or at least about one centimeter (e.g., at least about five centimeters, at least about ten centimeters, at least about 15 centimeters, at least about 20 centimeters, at least about 25 centimeters).

The particle chain can have a two-dimensional structure or a three-dimensional structure.

The particles can be connected by a link.

The link can have a length of at most about 50,000 microns (e.g., at most about 30,000 microns; at most about 10,000 microns; at most about 5,000 microns; at most about 1,000 microns; at most about 500 microns; at most about ten microns) and/or at least about one micron (e.g., at least about ten microns, at least about 500 microns; at least about 1,000 microns; at least about 5,000 microns; at least about 10,000 microns; at least about 30,000 microns).

The link can have a width of at most about 0.01 inch (e.g., at most 0.008 inch, at most 0.006 inch, at most 0.004 inch, at most 0.002 inch) and/or at least 0.001 inch (e.g., at least 0.002 inch, at least 0.004 inch, at least 0.006 inch, at least 0.008 inch).

The link can have an aspect ratio of at most about 1,000 (e.g., at most about 25 at most about five, at most 0.005) and/or at least 0.001 (e.g., at least 0.005, at least about five).

The ratio of the diameter of one of the particles to a width of the link can be at most about 100 (e.g., at most about 50, at most about ten, at most about five) and/or at least about 0.5 (e.g., at least about one, at least about five, at least about ten). The link can include a polymer. The polymer can be a polysaccharide (e.g., alginate).

The link can include a metal (e.g., platinum) and/or a fiber.

The link can include a material that is different from a material of at least one of the particles.

The link can be integrally formed with at least one of the particles. The particles can be two particles that are connected by a link that is integrally formed with the two particles.

The link can be attached to at least one of the particles. The at least two connected particles can be two particles that are connected by a link that is attached to the two particles.

The link can be bioabsorbable.

The link can include a therapeutic agent.

The particles can be connected by a polymer link that is grafted to the particles. The polymer link can include polyvinyl alcohol, alginate, polylactic acid, poly(lactic-co-glycolic) acid (PLGA), polyvinylpyrrolidone (PVP), and/or chitin.

The particles can include polyvinyl alcohol and can be connected by a link that includes chitin.

The particles can include polyvinyl alcohol and can be connected by a link that includes polyvinyl acetal.

The particles can include polyvinyl alcohol and can be connected by a link that includes polyvinylpyrrolidone.

The at least two connected particles can be five particles, ten particles, 100 particles, 500 particles, or 1,000 particles.

One of the at least two connected particles can be connected to the other particle.

One of the at least two connected particles can be connected to two particles.

The at least two connected particles can include first and second particles.

The first particle can include a first polymer and the second particle can include a second polymer.

The polymer (e.g., the first polymer) can be a polyvinyl alcohol, a polyacrylic acid, a polymethacrylic acid, a poly vinyl sulfonate, a carboxymethyl cellulose, a hydroxyethyl cellulose, a substituted cellulose, a polyacrylamide, a polyethylene glycol, a polyamide, a polyurea, a polyurethane, a polyester, a polyether, a polystyrene, a polysaccharide, a polylactic acid, a polyethylene, a polymethylmethacrylate, a polycaprolactone, a polyglycolic acid, a poly(lactic-co-glycolic) acid, or a combination thereof.

The first polymer can be a polysaccharide (e.g., alginate).

The first polymer can be the same as, or different from, the second polymer.

A diameter of the first particle can be the same as a diameter of the second particle. A diameter of the first particle can be different from a diameter of the second particle.

The first particle can include a first therapeutic agent (e.g., a radioactive species).

The second particle can include a second therapeutic agent, and the second therapeutic agent can be different from the first therapeutic agent.

At least one of the particles can include a ferromagnetic material, a radiopaque material, and/or a material that is visible by magnetic resonance imaging.

At least one of the particles can include a shape-memory material (e.g., a polymer, nitinol) and/or a superabsorbable polymer. The polymer in at least one of the particles can change shape to change the length of the filament between adjacent particles.

At least one of the particles can include an erodible coating.

The composition can further include a carrier fluid. The carrier fluid can include a saline solution and/or a contrast agent.

The gelling compound can be a polysaccharide (e.g., alginate).

The method can further include forming drops of the mixture.

The method can further include contacting the drops with a gelling agent.

The method can further include reacting the polymer.

The method can further include removing the gelling compound.

The method can further include combining the particles with a pharmaceutically acceptable medium.

The method can include forming a stream of the mixture through a nozzle and vibrating the nozzle at a vibration frequency of about 0.3 KHz or more.

The method can include forming a stream of the mixture through a nozzle and vibrating the nozzle at a vibration duty cycle of about 40/60 or lower (e.g., about 30/70, about 20/80).

The method can include forming drops of the mixture and contacting the drops with a cavity in a mold. The cavity can be electrostatically charged.

The method can further include grafting a second polymer to the at least two connected particles to form a link between the particles.

The method can further include forming a stream of the mixture and treating the stream with a gelling agent.

The method can further include forming a laminar stream of the mixture and exposing the stream to a non-uniform frequency.

The method of administration can be by percutaneous injection.

The method of administration can be by a device that has an internal opening and that is configured to fit within a body lumen. The device can have an internal opening and the composition can be disposed within the internal opening.

The method can further include using a saline flush and/or a pusher to deliver the composition from the device.

The device can have a member that is configured to disconnect the particles. The method can further include delivering at least one of the particles from the device, and using the member to disconnect the particles.

At least one of the particles can include a therapeutic agent. The method can include releasing the therapeutic agent from the particle or particles.

The method can further include administering a bioadhesive while administering the composition. The bioadhesive can include poly(ethylene oxide), carboxymethyl cellulose, or a cyanoacrylate.

The composition can be used to treat a cancer condition (e.g., ovarian cancer, colorectal cancer, thyroid cancer, gastrointestinal cancer, breast cancer, prostate cancer, lung cancer).

The method can include embolizing a body lumen (e.g., a body lumen associated with a cancer condition).

One or more of the cavities can contain a gelling agent, and forming the particles can include reacting a polymer with the gelling agent.

The method can further include forming drops (e.g., using a drop generator) that include the polymer and disposing the drops of the polymer in the cavities.

The cavities in the mold can be registered with a nozzle orifice of the drop generator.

The method can further include registering a cavity in the mold with a nozzle orifice of the drop generator, forming a drop of the polymer with the drop generator, and disposing the drop of the polymer in the cavity. The method can further include moving the cavity relative to the drop generator so that a different cavity in the mold is registered with the nozzle orifice of the drop generator.

The mold and the drop generator can be at different electrical potentials.

Embodiments can include one or more of the following advantages.

In some embodiments, a particle chain can serve as an efficient and effective way to deliver particles to a targeted location (e.g., within a body lumen during an embolization procedure). In certain embodiments, a high percentage of particles that are loaded into, for example, a body lumen can reach a targeted location within the body lumen.

In some embodiments, the delivery of a particle chain during an embolization procedure can result in a low occurrence of particle migration to non-targeted locations.

In some embodiments, a particle chain can be delivered to and confined within a discrete location (e.g., within a body lumen). In certain embodiments, the particle chain can form a dense and/or stable mass at the discrete location.

In some embodiments, a particle chain can be sized to correspond to, for example, a particular procedure, patient, and/or delivery means (e.g., a specific catheter). In some such embodiments, the particle chain can be sized prior to (e.g., immediately before) being delivered to a targeted site, or can be sized as it is delivered to a targeted site (e.g., by a physician operating a catheter).

Features and advantages are in the description, drawings, and claims.

### DESCRIPTION OF DRAWINGS

FIG. 1 is a side view of an embodiment of a particle chain.

FIG. 2A is a side view of an embodiment of an embolic composition in a syringe.

FIG. 2B is a schematic illustrating an embodiment of injection of the embolic composition of FIG. 2A into a vessel, and FIG. 2C is an enlarged view of the region 2C in FIG. 2B.

FIG. 3A is an illustration of an embodiment of a particle chain.

FIG. 3B is an illustration of an embodiment of a particle chain.

FIG. 3C is an illustration of an embodiment of a particle chain.

FIG. 4 is a side view of an embodiment of a particle chain.

FIG. 5 is a cross-sectional view of an embodiment of a particle.

FIG. 6 is an enlarged view of the particle chain of FIG. 1.

FIG. 7 is a side view of an embodiment of a particle chain.

FIG. 8A is a schematic of an embodiment of a system for manufacturing particles, and FIG. 8B is an enlarged schematic of region 8B in FIG. 8A.

FIGS. 9A-9D are an illustration of embodiments of a process for manufacturing particles.

FIG. 10 is an illustration of an embodiment of an apparatus for making particle chains.

FIG. 11 is a perspective view of an embodiment of a particle chain formed by the apparatus of FIG. 10.

FIG. 12 is a perspective view of an embodiment of a particle chain complex.

FIG. 13A is an illustration of an embodiment of a particle chain complex.

FIG. 13B is an illustration of an embodiment of a particle chain complex.

FIG. 13C is an illustration of an embodiment of a particle chain complex.

FIG. 14A is a cross-sectional side view of an embodiment of a particle chain.

FIG. 14B is a cross-sectional side view of the particle chain of FIG. 14A, in an expanded condition.

FIG. 15 is a cross-sectional side view of an embodiment of a particle chain.

### DETAILED DESCRIPTION

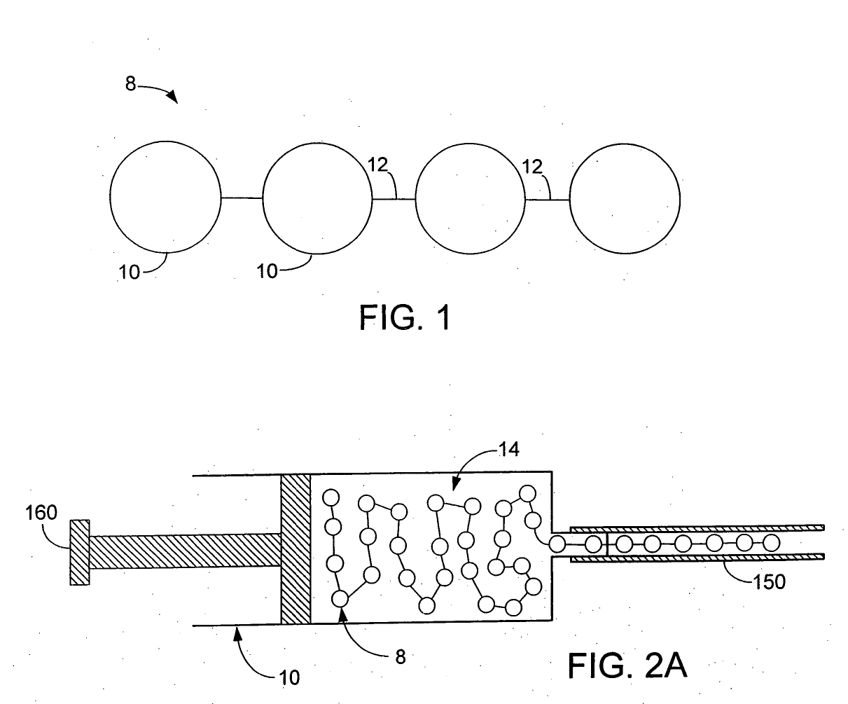

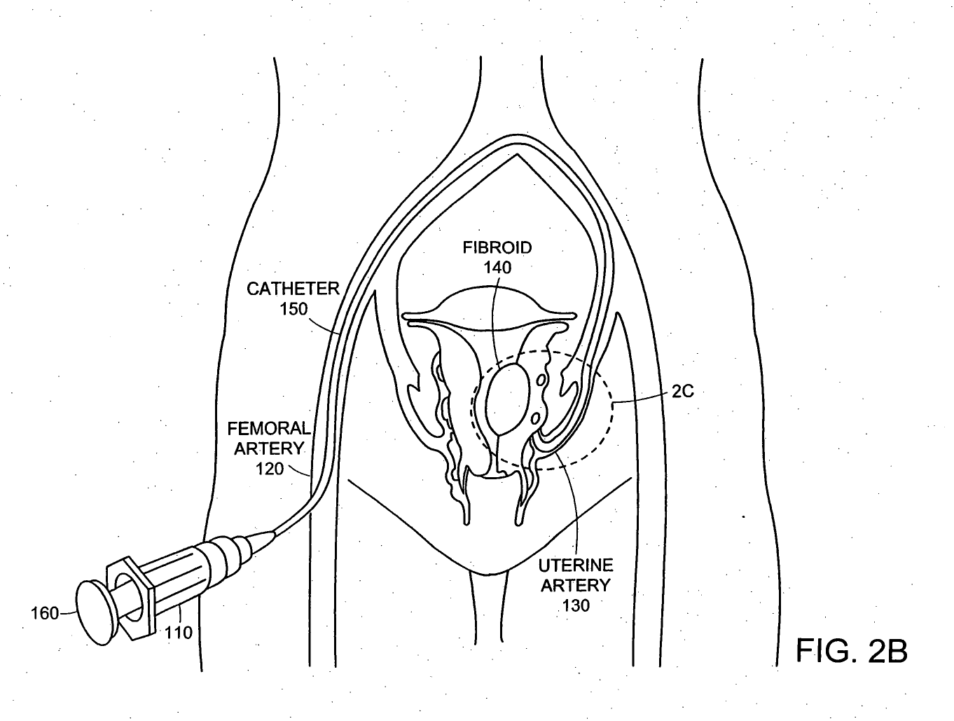

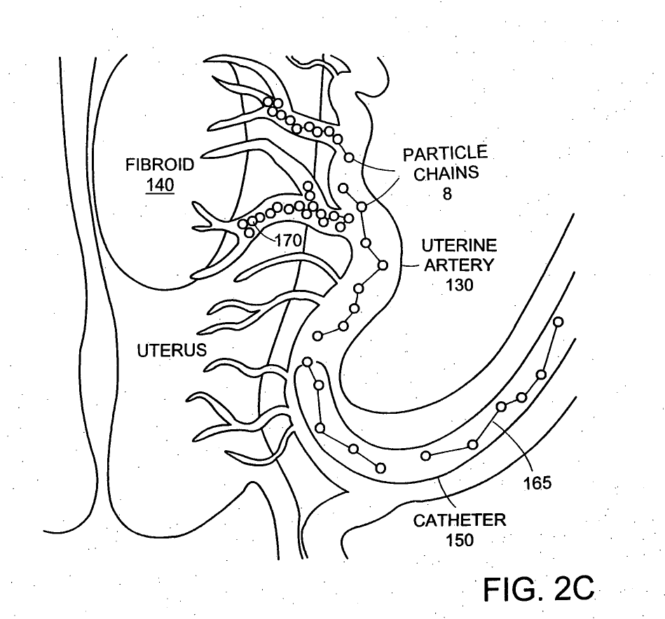

FIG. 1 shows a particle chain 8 that includes substantially spherical particles 10 connected by links 12. Typically, particle chain 8 is dimensioned so that it can be used in an embolic composition. For example, as shown in FIG. 2A, particle chain 8 is part of an embolic composition 14 that also includes a carrier fluid (e.g., a saline solution), and that is loaded into a syringe 110. Syringe 110 has a plunger 160 and is connected to a catheter 150. As plunger 160 is compressed, particle chain 8 is forced into catheter 150.

FIGS. 2B and 2C show the injection of embolic composition 14 into a uterine artery 130 of a female subject to, for example, occlude uterine artery 130, which leads to a fibroid 140 in the uterus of the female subject. First, catheter 150 is inserted into, and threaded through, a femoral artery 120. After being threaded through femoral artery 120, catheter 150 is inserted into uterine artery 130. As plunger 160 of syringe 110 is compressed, embolic composition 14 is delivered through catheter 150 into a lumen 165 of uterine artery 130. Thus, the force of pusher 160 acting against the carrier fluid flushes both the carrier fluid and particle chain 8 out of syringe 110, through catheter 150, and ultimately into uterine artery 130.

In FIG. 2C, which is an enlarged view of section 2C of FIG. 2B, uterine artery 130 is subdivided into smaller uterine vessels 170 (e.g., having a diameter of about two millimeters or less) which feed fibroid 140. Particle chains 8 from embolic composition 14 partially or totally fill the lumen of uterine artery 130, either partially or completely occluding the lumen of the uterine artery 130 that feeds uterine fibroid 140.

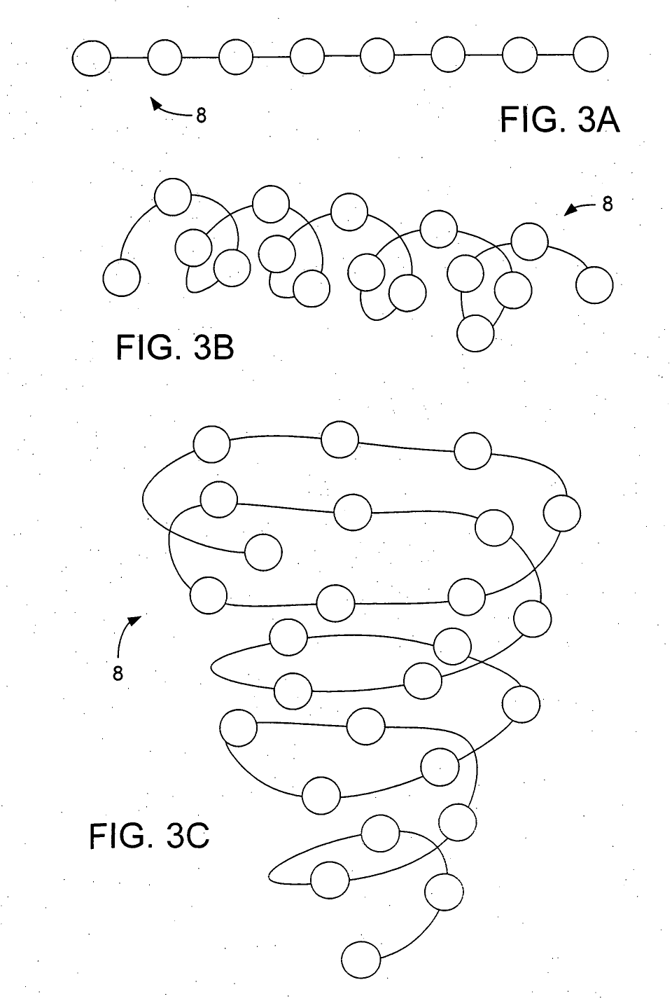

Prior to, during, or after injection, a particle chain 8 can take any of a number of different forms. As an example, and as shown in FIG. 3A, particle chain 8 can be in the form of a straight chain. As another example, and as shown in FIG. 3B, particle chain 8 can take the form of a coil or helix. As a further example, and as shown in FIG. 3C, particle chain 8 can take the form of a tornado.

The density of particle chain 8 (e.g., as measured in grams of material per unit volume) generally is such that particle chain 8 can be readily suspended in a carrier fluid (e.g., a pharmaceutically acceptable carrier, such as a saline solution, a contrast solution, or a mixture thereof) and remain suspended during delivery. In certain embodiments, the density of particle chain 8 is from about 1.1 grams per cubic centimeter to about 1.4 grams per cubic centimeter. As an example, for suspension in a saline-contrast solution, the density of particle chain 8 can be from about 1.2 grams per cubic centimeter to about 1.3 grams per cubic centimeter.

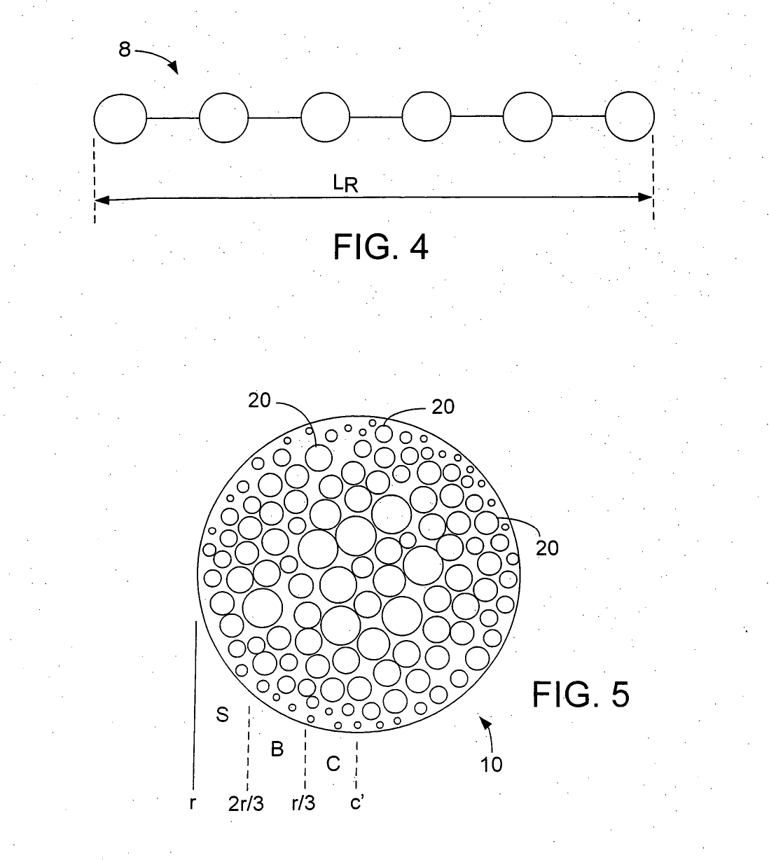

In general, particle chain 8 can have a restrained length of from about one centimeter to about 50 centimeters. As shown in FIG. 4, the restrained length L_{R} of particle chain 8 is the maximum length of particle chain 8 (the length of particle chain 8 when particle chain 8 is taut) in any dimension. In some embodiments, particle chain 8 can have a restrained length of at least about one centimeter (e.g., at least about five centimeters, at least about ten centimeters, at least about 15 centimeters, at least about 20 centimeters, at least about 25 centimeters, at least about 30 centimeters, at least about 35 centimeters, at least about 40 centimeters, at least about 45 centimeters) and/or at most about 50 centimeters (e.g., at most about 45 centimeters, at most about 40 centimeters, at most about 35 centimeters, at most about 30 centimeters, at most about 25 centimeters, at most about 20 centimeters, at most about 15 centimeters, at most about ten centimeters, at most about five centimeters).

Particle chain 8 includes at least two particles (e.g., from two particles to 1,000 particles). In some embodiments, particle chain 8 can include at least two particles (e.g., at least five particles; at least ten particles; at least 20 particles; at least 30 particles; at least 40 particles; at least 50 particles; at least 100 particles; at least 250 particles; at least 500 particles; at least 750 particles; at least 1,000 particles; at least 2,500 particles) and/or at most 5,000 particles (e.g., at most 2,500 particles; at most 1,000 particles; at most 750 particles; at most 500 particles; at most 250 particles; at most 100 particles; at most 50 particles; at most 40 particles; at most 30 particles; at most 20 particles; at most ten particles; at most five particles). For example, particle chain 8 can include five particles, ten particles, 100 particles, 500 particles, or 1,000 particles.

In general, a particle 10 has a diameter of about 3,000 microns or less (e.g., about 2,500 microns or less; about 2,000 microns or less; about 1,500 microns or less; about 1,200 microns or less; about 1,000 microns or less; about 900 microns or less; about 700 microns or less; about 500 microns or less; about 400 microns or less; about 300 microns or less; about 100 microns or less) and/or about ten microns or more (e.g., about 100 microns or more; about 300 microns or more; about 400 microns or more; about 500 microns or more; about 700 microns or more; about 900 microns or more; about 1,000 microns or more; about 1,200 microns or more; about 1,500 microns or more; about 2,000 microns or more; about 2,500 microns or more). In certain embodiments, the diameter of particle 10 can be from about ten microns to about 3,000 microns; from about 100 microns to about 700 microns; from about 500 microns to about 700 microns; from about 100 microns to about 500 microns; from about 100 microns to about 300 microns; from about 300 microns to about 500 microns; from about 500 microns to about 1,200 microns; from about 500 microns to about 700 microns; from about 700 microns to about 900 microns; from about 900 microns to about 1,200 microns.

The particles in particle chain 8 can all have approximately the same diameter or can have different diameters. As an example, in some embodiments, the particles at one end of particle chain 8 can have a larger diameter (e.g., by about 1100 microns) than the particles at the other end of particle chain 8. As another example, in certain embodiments, the particles in particle chain 8 can alternate in size. For example, particles with a diameter of about 300 microns can be adjacent to particles with a diameter of about 500 microns.

In some embodiments, among the particles in a particle chain delivered to a subject in an embolic composition, the majority (e.g., about 50 percent or more, about 60 percent or more, about 70 percent or more, about 80 percent or more, about 90 percent or more) of the particles have a diameter of about 3,000 microns or less (e.g., about 2,500 microns or less; about 2,000 microns or less; about 1,500 microns or less; about 1,200 microns or less; about 900 microns or less; about 700 microns or less; about 500 microns or less; about 400 microns or less; about 300 microns or less; about 100 microns or less) and/or about ten microns or more (e.g., about 100 microns or more; about 300 microns or more; about 400 microns or more; about 500 microns or more; about 700 microns or more; about 900 microns or more; about 1,200 microns or more; about 1,500 microns or more; about 2,000 microns or more; about 2,500 microns or more).

In certain embodiments, the particles in a particle chain delivered to a subject in an embolic composition have an arithmetic mean diameter of about 3,000 microns or less (e.g., about 2,500 microns or less; about 2,000 microns or less; about 1,500 microns or less; about 1,200 microns or less; about 900 microns or less; about 700 microns or less; about 500 microns or less; about 400 microns or less; about 300 microns or less; about 100 microns or less) and/or about ten microns or more (e.g., about 100 microns or more; about 300 microns or more; about 400 microns or more; about 500 microns or more; about 700 microns or more; about 900 microns or more; about 1,200 microns or more; about 1,500 microns or more; about 2,000 microns or more; about 2,500 microns or more). Exemplary ranges for the arithmetic mean diameter of particles in a particle chain delivered to a subject in an embolic composition include from about 100 microns to about 300 microns; from about 300 microns to about 500 microns; from about 500 microns to about 700 microns; and from about 900 microns to about 1,200 microns. In general, the particles in a particle chain delivered to a subject in an embolic composition have an arithmetic mean diameter in approximately the middle of the range of the diameters of the individual particles, and a variance of about 20 percent or less (e.g. about 15 percent or less, about ten percent or less). The arithmetic mean diameter of a group of particles can be determined using a Beckman Coulter RapidVUE Image Analyzer version 2.06 (Beckman Coulter, Miami, Fla.). Briefly, the RapidVUE takes an image of continuous-tone (gray-scale) form and converts it to a digital form through the process of sampling and quantization. The system software identifies and measures particles in an image in the form of a fiber, rod or sphere. The arithmetic mean diameter of a group of particles can be determined by dividing the sum of the diameters of all of the particles in the group by the number of particles in the group.

In some embodiments, the arithmetic mean diameter of the particles in a particle chain delivered to a subject in an embolic composition can vary depending upon the particular condition to be treated. As an example, in embodiments in which the particle chain in an embolic composition is used to treat a liver tumor, the particles in the particle chain delivered to the subject can have an arithmetic mean diameter of about 500 microns or less (e.g., from about 100 microns to about 300 microns; from about 300 microns to about 500 microns). As another example, in embodiments in which the particle chain in an embolic composition is used to treat a uterine fibroid, the particles in the particle chain delivered to the subject in an embolic composition can have an arithmetic mean diameter of about 1,200 microns or less (e.g., from about 500 microns to about 700 microns; from about 700 microns to about 900 microns; from about 900 microns to about 1,200 microns).

A particle 10 can be substantially formed of a polymer (generally, a biocompatible polymer). Examples of polymers include polyvinyl alcohols, polyacrylic acids, polymethacrylic acids, poly vinyl sulfonates, carboxymethyl celluloses, hydroxyethyl celluloses, substituted celluloses, polyacrylamides, polyethylene glycols, polyamides, polyureas, polyurethanes, polyesters, polyethers, polystyrenes, polysaccharides, polylactic acids, polyethylenes, polymethylmethacrylates, polycaprolactones, polyglycolic acids, poly(lactic-co-glycolic) acids (e.g., poly(d-lactic-co-glycolic) acids), and copolymers or mixtures thereof. In some embodiments, particle 10 can be substantially formed of a highly water insoluble, high molecular weight polymer. An example of such a polymer is a high molecular weight polyvinyl alcohol (PVA) that has been acetalized. Particle 10 can be substantially pure intrachain 1,3-acetalized PVA and substantially free of animal derived residue such as collagen. In some embodiments, particle 10 includes a minor amount (e.g., about 2.5 weight percent or less, about one weight percent or less, about 0.2 weight percent or less) of a gelling material (e.g., a polysaccharide, such as alginate). In certain embodiments, the majority (e.g., at least about 75 weight percent, at least about 90 weight percent, at least about 95 weight percent) of particle 10 is formed of a bioabsorbable polymer (e.g., polysaccharide, such as alginate).

The particles in particle chain 8 can all be formed of the same material or can be formed of different materials. For example, all of the particles in particle chain 8 can be formed of the same polymer (e.g., a polyvinyl alcohol). Alternatively, some of the particles can be formed of, for example, one polymer (e.g., a polyvinyl alcohol), while others of the particles can be formed of a different polymer (e.g., alginate).

FIG. 5 shows a cross-sectional view of a particle 10. As shown in FIG. 5, particle 10 includes pores 20 and can be considered to include a center region, C, from the center c′ of particle 10 to a radius of about r/3, a body region, B, from about r/3 to about 2 r/3, and a surface region, S, from about 2r/3 to r. The regions can be characterized by the relative size of pores 20 present in particle 10 in each region, the density of pores 20 (the number of pores 20 per unit volume of particle 10) in each region, and/or the mass density in each region.

In general, the mean size of pores 20 in region C of particle 10 is greater than the mean size of pores 20 at region S of particle 10. In some embodiments, the mean size of pores 20 in region C of particle 10 is greater than the mean size of pores 20 in region B particle 10, and/or the mean size of pores 20 in region B of particle 10 is greater than the mean size of pores 20 at region S particle 10. In some embodiments, the mean size of pores 20 in region C is about 20 microns or more (e.g., about 30 microns or more, from about 20 microns to about 35 microns). In certain embodiments, the mean size of pores 20 in region B is about 18 microns or less (e.g. about 15 microns or less, from about 18 microns to about two microns). In some embodiments, the mean size of pores 20 in region S is about one micron or less (e.g. from about 0.1 micron to about 0.01 micron). In certain embodiments, the mean size of pores 20 in region B is from about 50 percent to about 70 percent of the mean size of pores 20 in region C, and/or the mean size of pores 20 at region S is about ten percent or less (e.g., about two percent or less) of the mean size of pores 20 in region B. In some embodiments, the surface of particle 10 and/or its region S is/are substantially free of pores having a diameter greater than about one micron (e.g., greater than about ten microns). In certain embodiments, the mean size of pores 20 in the region from 0.8r to r (e.g., from 0.9r to r) is about one micron or less (e.g., about 0.5 micron or less, about 0.1 micron or less). In some embodiments, pores 20 in the region from the center of particle 10 to 0.9r (e.g., from the center of particle 10 to 0.8r) are about ten microns or greater and/or have a mean size of from about two microns to about 35 microns. In certain embodiments, the mean size of pores 20 in the region from 0.8r to r (e.g., from 0.9r to r) is about five percent or less (e.g., about one percent or less, about 0.3 percent or less) of the mean size of pores 20 in the region from the center to 0.9r. In some embodiments, the largest pores in particle 10 can have a size in the range of about one percent or more (e.g., about five percent or more, about ten percent or more) of the diameter of particle 10. The size of pores 20 in particle 10 can be measured by viewing a cross-section of particle 10. For irregularly shaped (nonspherical) pores, the maximum visible cross-section is used.

Generally, the density of pores 20 in region C of particle 10 is greater than the density of pores 20 at region S of particle 10. In some embodiments, the density of pores 20 in region C of particle 10 is greater than the density of pores 20 in region B of particle 10, and/or the density of pores 20 in region B of particle 10 is greater than the density of pores 20 at region S of particle 10.

In general, the mass density in region C of particle 10 is less than the mass density at region S of particle 10. In some embodiments, the mass density in region C of particle 10 is less than the mass density in region B of particle 10, and/or the mass density in region B of particle 10 is less than the mass density at region S of particle 10.

In general, the density of particle 10 (e.g., as measured in grams of material per unit volume) is such that it can be readily suspended in a carrier fluid (e.g., a pharmaceutically acceptable carrier, such as a saline solution, a contrast solution, or a mixture thereof) and remain suspended during delivery. In some embodiments, the density of particle 10 is from about 1.1 grams per cubic centimeter to about 1.4 grams per cubic centimeter. As an example, for suspension in a saline-contrast solution, the density of particle 10 can be from about 1.2 grams per cubic centimeter to about 1.3 grams per cubic centimeter.

In certain embodiments the region of small pores near the surface of particle 10 can be relatively stiff and incompressible, which can enhance resistance to shear forces and abrasion. In addition, the variable pore size profile can produce a symmetric compressibility and, it is believed, a compressibility profile. As a result, particle 10 can be relatively easily compressed from a maximum, at rest diameter to a smaller, compressed first diameter. Compression to an even smaller diameter, however, may involve substantially greater force. Without wishing to be bound by theory, it is believed that a variable compressibility profile can be the result of a relatively weak, collapsible inter-pore wall structure in the center region of particle 10 (where the pores are relatively large), and a stiffer inter-pore wall structure near the surface of particle 10 (where the pores are more numerous and relatively small). It is further believed that a variable pore size profile can enhance elastic recovery after compression. It is also believed that the pore structure can influence the density of particle 10 and the rate of carrier fluid or body fluid uptake.

In some embodiments, particle chain 8 can be delivered through a catheter having a lumen with a cross-sectional area that is smaller (e.g., about 50 percent or less) than the uncompressed cross-sectional area of particle 10. In such embodiments, particle 10 is compressed to pass through the catheter for delivery into the body. Typically, the compression force is provided indirectly, by depressing the syringe plunger to increase the pressure applied to the carrier fluid. In general, particle 10 is relatively easily compressed to a diameter sufficient for delivery through the catheter into the body. The relatively robust, rigid surface region of particle 10 can resist abrasion when particle 10 contacts hard surfaces such as syringe surfaces, hard plastic or metal stopcock surfaces, and/or the catheter lumen wall (made of, e.g., Teflon) during delivery of particle chain 8. Once in the body, particle 10 can substantially recover to original diameter and shape for efficient transport in the carrier and body fluid stream. At the point of occlusion, particle 10 can again compress as it aggregates with other particles in the occlusion region (e.g., other particles in particle chain 8). The particles can form a relatively dense occluding mass. The compression of the particles in the body is generally determined by the force provided by body fluid flow in the lumen. In some embodiments, the compression may be limited by the compression profile of the particles, and the number of particles needed to occlude a given diameter may be reduced.

In some embodiments, particle 10 can have a sphericity of about 0.8 or more (e.g., about 0.85 or more, about 0.9 or more, about 0.95 or more, from about 0.8 to about 1, from about 0.9 to about 1) prior to compression in a catheter. In certain embodiments, the sphericity of particle 10 after compression in a catheter (e.g., after compression to about 50 percent or more of the cross-sectional area of particle 10) is about 0.8 or more (e.g., about 0.85 or more, about 0.9 or more, about 0.95 or more, about 0.97 or more). Particle 10 can be, for example, manually compressed, essentially flattened, while wet to about 50 percent or less of its original diameter and then, upon exposure to fluid, regain a sphericity of about 0.8 or more (e.g., about 0.85 or more, about 0.9 or more, about 0.95 or more, about 0.97 or more). The sphericity of a particle can be determined using a Beckman Coulter RapidVUE Image Analyzer version 2.06 (Beckman Coulter, Miami, Fla.), described above. The sphericity of a particle, which is computed as Da/Dp (where Da=√(4A/π); Dp=P/π; A=pixel area; P=pixel perimeter), is a value from zero to one, with one representing a perfect circle.

Porous particles are described, for example, in U.S. patent application Ser. No. 10/637,130, filed on Aug. 8, 2003, and entitled “Embolization”, which is incorporated herein by reference.

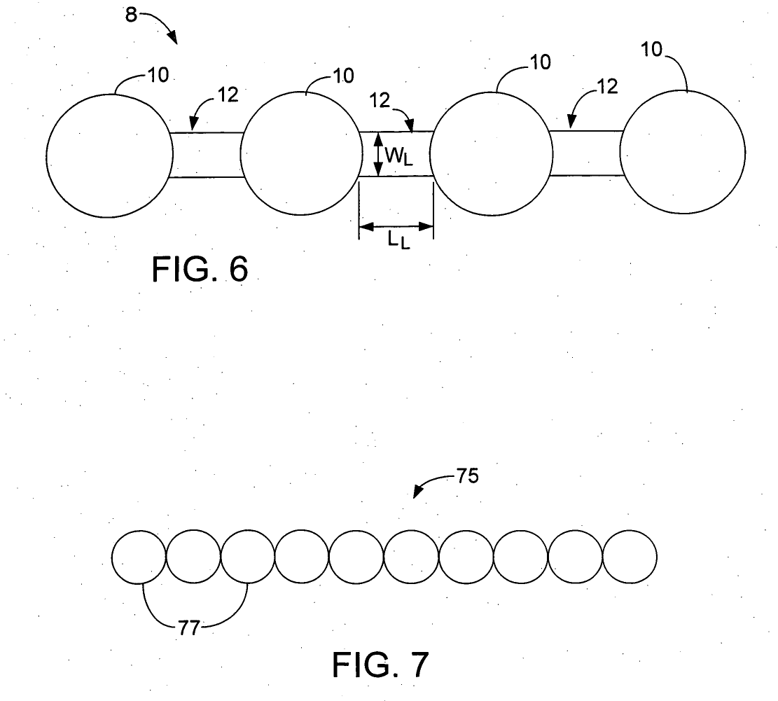

FIG. 6 shows an enlarged view of particle chain 8, in which a link 12 has a length L_{L} and a width W_{L}. In general, link 12 can have a length of from about one micron to about 50,000 microns. In some embodiments, link 12 can have a length of at least about one micron (e.g., at least about five microns; at least about ten microns; at least about 50 microns; at least about 100 microns; at least about 500 microns; at least about 1,000 microns; at least about 5,000 microns; at least about 10,000 microns; at least about 15,000 microns; at least about 20,000 microns; at least about 25,000 microns; at least about 30,000 microns; at least about 35,000 microns; at least about 40,000 microns; at least about 45,000 microns) and/or at most about 50,000 microns (e.g., at most about 45,000 microns; at most about 40,000 microns; at most about 35,000 microns; at most about 30,000 microns; at most about 25,000 microns; at most about 20,000 microns; at most about 15,000 microns; at most about 10,000 microns; at most about 5,000 microns; at most about 1,000 microns; at most about 500 microns; at most about 100 microns; at most about 50 microns; at most about ten microns; at most about five microns).

Link 12 generally can have a width of from 0.001 inch to about 0.01 inch (e.g., from 0.003 inch to 0.005 inch). In certain embodiments, link 12 can have a width of at least 0.001 inch (e.g., at least 0.002 inch, at least 0.003 inch, at least 0.004 inch, at least 0.005 inch, at least 0.006 inch, at least 0.007 inch, at least 0.008 inch, at least 0.009 inch) and/or at most about 0.01 inch (e.g., at most 0.009 inch, at most 0.008 inch, at most 0.007 inch, at most 0.006 inch, at most 0.005 inch, at most 0.004 inch, at most 0.003 inch, at most 0.002 inch).

In some embodiments, links 12 in particle chain 8 can all have approximately the same length and/or width. In other embodiments, particle chain 8 can include links of varying lengths and/or widths. As an example, in certain embodiments, one end of a particle chain can have relatively short, thick links, while the other end of the particle chain has relatively long, thin links. As another example, in some embodiments, links 12 in particle chain 8 can alternate between being relatively short and thick and relatively long and thin.

In general, link 12 can have an aspect ratio (the ratio of the length of the link to the width of the link) of from about zero to about 1,000. In some embodiments, link 12 can have an aspect ratio of at least 0.001 (e.g., at least 0.005, at least about 0.5, at least about one, at least about five, at least about ten, at least about 15, at least about 20, at least about 25, at least about 26, at least about 30, at least about 40, at least about 50, at least about 75, at least about 100, at least about 200, at least about 300, at least about 400, at least about 500, at least about 600, at least about 700 , at least about 800, at least about 900 ) and/or at most about 1,000 (e.g., at most about 900 , at most about 800, at most about 700 , at most about 600, at most about 500, at most about 400, at most about 300, at most about 200, at most about 100, at most about 75, at most about 50, at most about 40, at most about 30, at most about 26, at most about 25, at most about 20, at most about 15, at most about ten, at most about five, at most about one, at most about 0.5, at most 0.005).

In general, the aspect ratio of link 12 can be varied as desired. Typically, as the aspect ratio of link 12 increases, the flexibility of link 12 increases. As the aspect ratio of link 12 decreases, the tensile strength of link 12 typically increases.

In some embodiments, the ratio of the diameter of particle 10 to the width of link 12 can be from about 0.5 to about 100. The ratio can be at least about 0.5 (e.g., at least about 0.8, at least about one, at least about two, at least about five, at least about ten, at least about 12, at least about 15, at least about 20, at least about 25, at least about 30, at least about 35, at least about 40, at least about 45, at least about 50, at least about 55, at least about 60, at least about 70, at least about 80, at least about 90) and/or at most about 100 (e.g., at most about 90, at most about 80, at most about 70, at most about 60, at most about 55, at most about 50, at most about 45, at most about 40, at most about 35, at most about 30, at most about 25, at most about 20, at most about 15, at most about 12, at most about ten, at most about five, at most about two, at most about one, at most about 0.8).

Generally, the ratio of the diameter of particle 10 to the width of link 12 can be varied as desired. Typically, as the ratio of the diameter of particle 10 to the width of link 12 increases, the flexibility of link 12 increases. As the ratio of the diameter of particle 10 to the width of link 12 decreases, the tensile strength of link 12 typically increases.

Link 12 can be substantially formed of, for example, one or more polymers, metals, metal alloys, and/or fibers. Generally, the material or materials used to form link 12 is (are) biocompatible.

Examples of polymers include polyvinyl alcohols, polyacrylic acids, polymethacrylic acids, poly vinyl sulfonates, carboxymethyl celluloses, hydroxyethyl celluloses, substituted celluloses, polyacrylamides, polyethylene glycols, polyamides (e.g., nylon), polyureas, polyurethanes, polyesters, polyethers, polystyrenes, polysaccharides (e.g., alginate), polylactic acids, polyethylenes, polymethylmethacrylates, polycaprolactones, polyglycolic acids, poly(lactic-co-glycolic) acids, and combinations thereof.

Examples of metals include platinum, titanium, and zirconium. Examples of metal alloys include stainless steel, nitinol, and Vitallium™.

Examples of materials that can be used to form a fibrous link 12 include poly(ethylene terephthalate) and nylon.

Links 12 and particles 10 in particle chain 8 can be formed of the same material or can be formed of different materials. In some embodiments, links 12 and particles 10 can all be formed of the same material (e.g., a polymer such as a polyvinyl alcohol). In other embodiments, links 12 and particles 10 can be formed of different materials. For example, links 12 can be formed of one material (e.g., a metal such as platinum), while particles 10 can be formed of a different material (e.g., a polymer such as a polyvinyl alcohol).

While a particle chain with links has been described, in some embodiments a particle chain can include particles that are joined together without links. For example, FIG. 7 shows a particle chain 75 formed of particles 77 that are joined together without the use of links. Particles 77 can be joined to each other by a material such as an adhesive. Alternatively or additionally, the surfaces of particles 77 can be sticky and/or tacky so that particles 77 stick to each other when they come into contact, forming particle chain 75.

In general, various methods can be used to prepare particle chain 8. In some embodiments, particles 10 are formed using a drop generator.

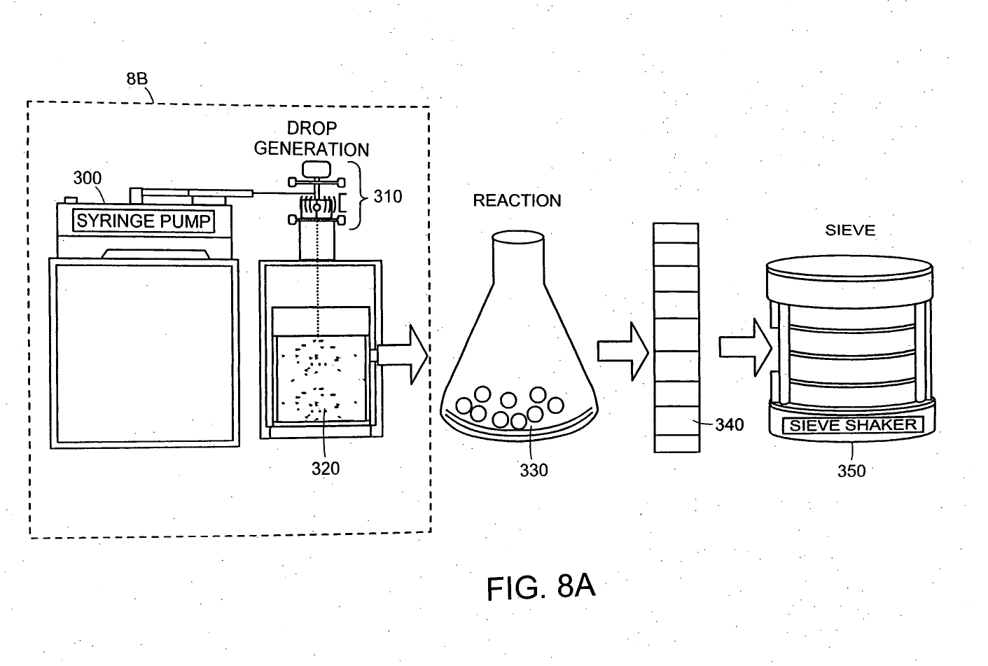

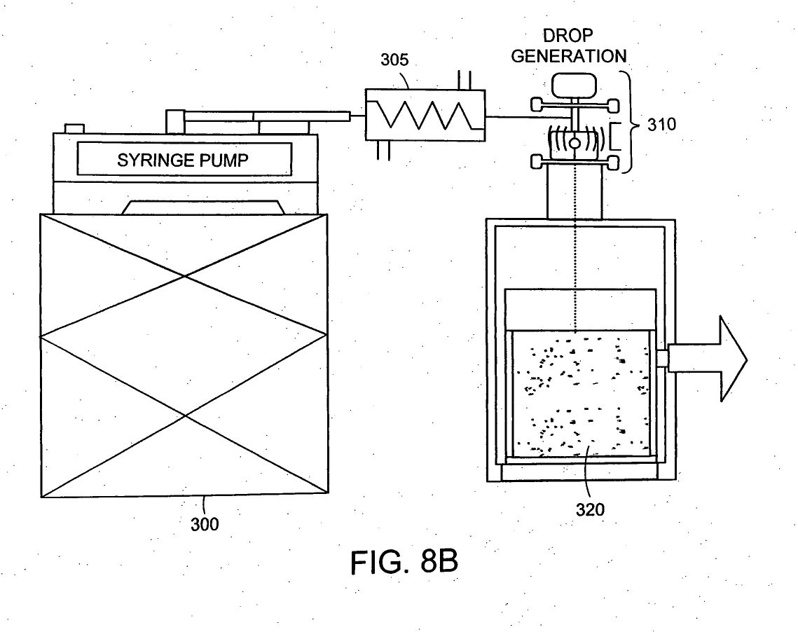

FIG. 8A shows an embodiment of a system for producing particles 10. The system includes a flow controller 300, a drop generator 310, a gelling vessel 320, a reactor vessel 330, a gel dissolution chamber 340 and a filter 350. As shown in FIG. 8B, flow controller 300 delivers a solution that contains a base polymer (e.g., a polyvinyl alcohol) and a gelling precursor (e.g., alginate) to a viscosity controller 305, which heats the solution to reduce viscosity prior to delivery to drop generator 310. The solution passes through an orifice in a nozzle in drop generator 310, forming drops of the solution.

Drop generator 310 generates substantially spherical drops of a predetermined diameter by forcing the solution of the base polymer/gelling precursor mixture as a stream through the nozzle orifice. The nozzle is subjected to a periodic disturbance to break up the jet stream of the mixture into drops of the mixture. The jet stream can be broken into drops by vibratory action generated, for example, by an electrostatic or piezoelectric element. The drop size can be controlled, for example, by controlling the nozzle orifice diameter, base polymer/gelling precursor flow rate, nozzle vibration amplitude, and nozzle vibration frequency. In general, holding other parameters constant, increasing the nozzle orifice diameter results in formation of larger drops, and increasing the flow rate results in larger drops. Generally, holding other parameters constant, increasing the nozzle vibration amplitude results in larger drops, and reducing the nozzle vibration frequency results in larger drops. In general, the nozzle orifice diameter can be about 500 microns or less (e.g., about 400 microns or less, about 300 microns or less, about 200 microns or less, about 100 microns or less) and/or about 50 microns or more. The flow rate through the drop generator is typically from about one milliliter per minute to about 12 milliliters per minute. Generally, the nozzle frequency used can be about 0.05 KHz or more (e.g., about 0.1 KHz or more, about 0.15 KHz or more, about 0.2 KHz or more, about 0.25 KHz or more, about 0.8 KHz or more, about 1.5 KHz or more, about 1.75 KHz or more, about 1.85 KHz or more, about 2.5 KHz or more, from about 0.05 KHz to about 0.8 KHz, from about 0.1 KHz to about 0.8 KHz). In general, the nozzle vibration amplitude is larger than the width of the jet stream. The drop generator can have a variable nozzle vibration amplitude setting, such that an operator can adjust the amplitude of the nozzle vibration. In some embodiments, the nozzle vibration amplitude is set at between about 80 percent and about 100 percent of the maximum setting.

An example of a commercially available electrostatic drop generator is the model NISCO Encapsulation unit VAR D (NISCO Engineering, Zurich, Switzerland). Another example of a commercially available drop generator is the Inotech Encapsulator unit IE-50R/NS (Inotech AG, Dottikon, Switzerland).

After the drops have been formed by drop generator 310, the drops are directed into gelling vessel 320, where the drops contact a gelling agent that converts the gelling precursor from a solution form into a gel form, stabilizing the drops. In some embodiments, drop generator 310 can charge the drops after formation, such that mutual repulsion between drops prevents drop aggregation as the drops travel from drop generator 310 to gelling vessel 320. Charging may be achieved, for example, by an electrostatic charging device such as a charged ring positioned downstream of the nozzle.

As described above, after being formed by drop generator 310, drops of the base polymer and gelling precursor mixture are captured in gelling vessel 320. The distance between gelling vessel 320 and the orifice of the nozzle in drop generator 310 can be selected so that the jet stream of the base polymer/gelling precursor mixture is substantially broken up into discrete drops before reaching gelling vessel 320. In some embodiments, the distance from the nozzle orifice to the mixture contained in gelling vessel 320 is from about five inches to about six inches.

The mixture contained in gelling vessel 320 includes a gelling agent which interacts with the gelling precursor to stabilize drops by forming a stable gel. Suitable gelling agents include, for example, a divalent cation such as alkali metal salt, alkaline earth metal salt or a transition metal salt that can ionically cross-link with the gelling agent. An inorganic salt, for example, a calcium, barium, zinc or magnesium salt can be used as a gelling agent. In embodiments, particularly those using an alginate gelling precursor, a suitable gelling agent is calcium chloride. The calcium cations have an affinity for carboxylic groups in the gelling precursor. The cations complex with carboxylic groups in the gelling precursor, resulting in encapsulation of the base polymer in a matrix of gelling precursor.

Without wishing to be bound by theory, it is believed that in some embodiments (e.g., when forming particles having a diameter of about 500 microns or less), it can be desirable to reduce the surface tension of the mixture contained in gelling vessel 320. This can be achieved, for example, by heating the mixture in gelling vessel 320 (e.g., to a temperature greater than room temperature, such as a temperature of about 30° C. or more), by bubbling a gas (e.g., air, nitrogen, argon, krypton, helium, neon) through the mixture contained in gelling vessel 320, by stirring (e.g., via a magnetic stirrer) the mixture contained in gelling vessel 320, by including a surfactant in the mixture containing the gelling agent, and/or by forming a mist containing the gelling agent above the mixture contained in gelling vessel 320 (e.g., to reduce the formation of tails and/or enhance the sphericity of the particles).

Following drop stabilization, the gelling solution can be decanted from the solid drops, or the solid drops can be removed from the gelling solution by sieving. The solid drops are then transferred to reactor vessel 330, where the base polymer in the solid drops is reacted (e.g., cross-linked) to produce precursor particles.

Reactor vessel 330 contains an agent that chemically reacts with the base polymer to cause cross-linking between polymer chains and/or within a polymer chain. The agent diffuses into the solid drops from the surface of the particle in a gradient which, it is believed, provides more cross-linking near the surface of the solid drop than in the body and center of the drop. Reaction is greatest at the surface of a solid drop, providing a stiff, abrasion-resistant exterior. For polyvinyl alcohol, for example, vessel 330 includes one or more aldehydes, such as formaldehyde, glyoxal, benzaldehyde, aterephthalaldehyde, succinaldehyde and glutaraldehyde for the acetalization of polyvinyl alcohol. Vessel 330 also includes an acid, for example, strong acids such as sulfuric acid, hydrochloric acid, nitric acid and weak acids such as acetic acid, formic acid and phosphoric acid. In embodiments, the reaction is primarily a 1,3-acetalization:

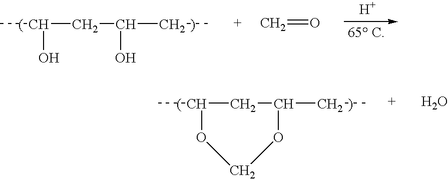

This intra-chain acetalization reaction can be carried out with relatively low probability of inter-chain cross-linking, as described in John G. Pritchard, “Poly(Vinyl Alcohol) Basic Properties and Uses (Polymer Monograph, vol. 4) (see p. 93-97), Gordon and Breach, Science Publishers Ltd., London, 1970, which is incorporated herein by reference. Because the reaction proceeds in a random fashion, some OH groups along a polymer chain might not react with adjacent groups and may remain unconverted.

Adjusting for the amounts of aldehyde and acid used, reaction time and reaction temperature can control the degree of acetalization. In embodiments, the reaction time is from about five minutes to about one hour (e.g., from about 10 minutes to about 40 minutes, about 20 minutes). The reaction temperature can be, for example, from about 25° C. to about 150° C. (e.g., from about 75° C. to about 130° C., about 65° C.). Reactor vessel 330 can be placed in a water bath fitted with an orbital motion mixer. The cross-linked precursor particles are washed several times with deionized water to neutralize the particles and remove any residual acidic solution.

The precursor particles are transferred to dissolution chamber 340, where the gelling precursor (which was converted to a gel) is removed (e.g., by an ion exchange reaction). In embodiments, sodium alginate is removed by ion exchange with a solution of sodium hexa-metaphosphate (EM Science). The solution can include, for example, ethylenediaminetetracetic acid (EDTA), citric acid, other acids, and phosphates. The concentration of the sodium hexa-metaphosphate can be, for example, from about one weight percent to about 20 weight percent (e.g., from about one weight percent to about ten weight percent, about five weight percent) in deionized water. Residual gelling precursor (e.g., sodium alginate) can be measured by assay (e.g., for the detection of uronic acids in, for example, alginates containing mannuronic and guluronic acid residues). A suitable assay includes rinsing the particles with sodium tetraborate in sulfuric acid solution to extract alginate, combining the extract with metahydroxydiphenyl colormetric reagent, and determining concentration by UV/VIS spectroscopy. Testing can be carried out by alginate suppliers such as FMC Biopolymer, Oslo, Norway. Residual alginate may be present in the range of, for example, from about 20 weight percent to about 35 weight percent prior to rinsing, and in the range of from about 0.01 weight percent to about 0.5 weight percent (e.g., from about 0.1 weight percent to about 0.3 weight percent, about 0.18 weight percent) in the particles after rinsing for 30 minutes in water at about 23° C.

The particles are then filtered in filter 350 to remove debris.

Methods of making particles are described, for example, in U.S. patent application Ser. No. 10/637,130, filed on Aug. 8, 2003, and entitled “Embolization”, which is incorporated herein by reference.

After particles 10 have been formed (e.g., by the drop generation process described above), they can be linked together using links 12, to form one or more particle chains 8. Links 12 can be attached to particles 10 by, for example, bonding (e.g., using an adhesive, such as cyanoacrylate or methacrylate). In some embodiments, particles 10 can be attached to each other by threading a link material (e.g., a metal wire, such as a platinum wire) through particles 10. Examples of link materials that can be threaded through particles 10 include metal wire (e.g., platinum wire, stainless steel wire), and nitinol. In certain embodiments, links 12 can be formed of a polymer that is grafted to particles 10. Examples of polymers that can be grafted to particles 10 include polyvinyl alcohols, polyethylenes (PE), polypropylenes (PP), polybutylenes (PB), polyisobutylenes (PIB), polystyrenes (PS), poly a-methylstyrene, polyacrylonitrile (PAN), polyvinylpyrrolidone (PVP), PVAL, polyisoprene, polybutadine, ethylene-propylene-diene-monomer (EPDM), polyvinylether, PVA\PLGA, PVA-g-PLA, PVA-g-PLGA, PVB-g-PLGA, chitin, polyacrylates, substituted polyacrylates, other polyolefins and polydienes and combinations and copolymers of any of these polymers.

In some embodiments, the above-described drop generation process can be manipulated so that links 12 are formed integrally with particles 10. In such embodiments, drop generator 310 can be employed to form drops according to the procedure described above with reference to FIGS. 8A and 8B. However, one or more of the parameters of the process can be varied in order to produce drops that, rather than being discrete, are connected to each other by links formed of the same material as the drops. For example, the nozzle vibration amplitude and/or nozzle vibration duty cycle and/or nozzle vibration frequency can be varied to prevent the formation of discrete drops, and to cause drop generator 310 to form drops with satellites and/or drops that are connected to each other by links (particle chains).

In general, as the nozzle vibration amplitude of drop generator 310 decreases, the drops formed by drop generator 310 can become less discrete. At a sufficiently low nozzle vibration amplitude, particle chains 8 can form. In embodiments in which it is desirable to form particle chains 8, the nozzle vibration amplitude of drop generator 310 can be set at less than about 80 percent (e.g., from about 50 percent to about 80 percent, about 75 percent, about 70 percent, about 65 percent) of the maximum setting. In a NISCO Encapsulation unit VAR D, for example, the maximum setting is ten Volts. Thus, when the nozzle vibration amplitude of the NISCO Encapsulation unit VAR D is set at 100 percent, the corresponding voltage of the unit is ten Volts. Similarly, 80 percent corresponds to eight Volts, 75 percent corresponds to 7.5 Volts, 70 percent corresponds to seven Volts, and 65 percent corresponds to 6.5 Volts.

Typically, as the nozzle vibration duty cycle of drop generator 310 decreases, the drops formed by drop generator 310 can become less discrete. The duty cycle represents the amount of time it takes for drop generator 310 to produce one drop (the cycle), and the percentage of that time during which the power of drop generator 310 is turned on, followed by the percentage of time during which the power of drop generator 310 is turned off. For example, if drop generator 310 has a duty cycle of 60/40, then during the cycle of time it takes to produce one drop, the power of drop generator 310 is on for the first 60 percent of the cycle and off for the remaining 40 percent of the cycle.

In some embodiments in which drop generator 310 is set at a duty cycle of 50/50 (50% power on followed by 50% power off), drop generator 310 can produce discrete, substantially spherical drops. In some embodiments in which drop generator 310 is set at a duty cycle of 40/60 (40% power on followed by 60% power off) or lower (e.g., 30/70, 20/80), drop generator 310 can produce particle chains 8.

Generally, as the nozzle vibration frequency of drop generator 310 increases, the drops formed by drop generator 310 can become less discrete. At a sufficiently high nozzle vibration frequency, particle chains 8 can form. In embodiments in which it is desirable to form particle chains 8, the nozzle vibration frequency of drop generator 310 can be about 0.3 KHz or more (e.g., from about 0.3 KHz to about 0.7 KHz, about 0.3 KHz, about 0.4 KHz, about 0.5 KHz, about 0.6 KHz, about 0.7 KHz).

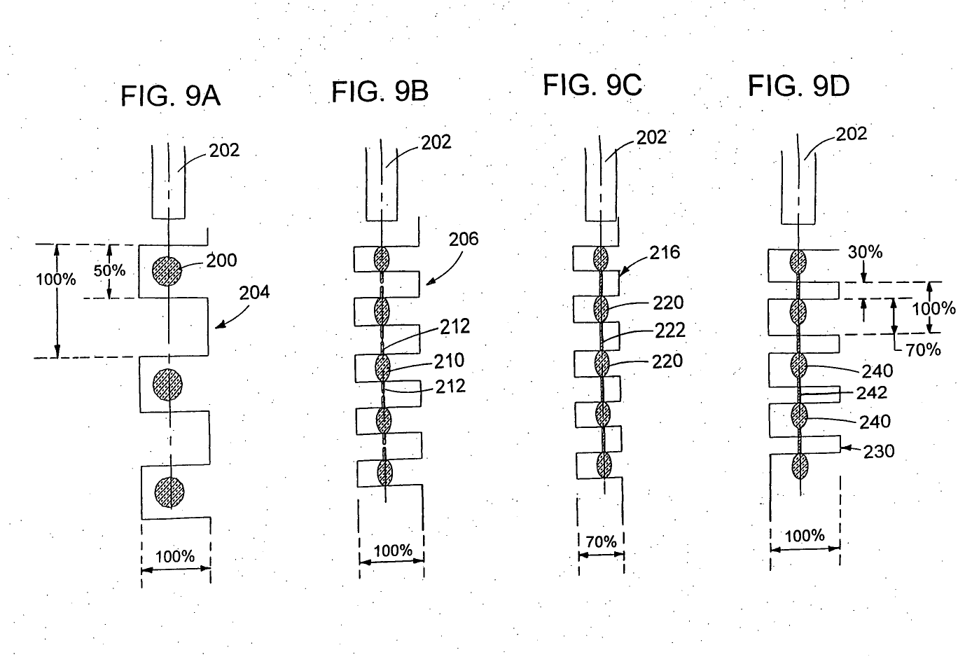

FIGS. 9A-9D show embodiments in which the nozzle vibration frequency, amplitude, and duty cycle of a drop generator nozzle 202 are varied. First, FIG. 9A shows the formation of substantially spherical drops 200 through nozzle 202 at a nozzle vibration represented by a waveform 204. Waveform 204 has a complete vibration cycle of 100%, a nozzle vibration duty cycle of 50/50, and a nozzle vibration amplitude of 100%. FIG. 9B shows an embodiment in which nozzle 202 (illustrated by waveform 206) vibrates at a frequency that is higher than the frequency shown in FIG. 9A. At the higher frequency, the drops 210 that form have satellites 212. If the nozzle vibration frequency is further increased, then the satellites can turn into links that connect the drops to each other, forming particle chains. FIG. 9C shows the vibration of nozzle 202 (illustrated by waveform 216) at an amplitude of 70%, which is lower than the amplitude of waveform 204 in FIG. 9A. At the lower amplitude, the drops 220 that form are connected to each other by links 222. Finally, FIG. 9D shows the vibration of nozzle 202 (illustrated by waveform 230) at a duty cycle of 30/70, which is lower than the duty cycle shown in FIG. 9A. When the nozzle vibration duty cycle is decreased to 30/70, the drops 240 that form are connected to each other by links 242.

In some embodiments, particle chains 8 can be formed by altering the distance between gelling vessel 320 and the nozzle orifice of drop generator 310. In certain embodiments, the distance between gelling vessel 320 and the nozzle orifice of drop generator 310 can be decreased such that the stream of solution through the nozzle orifice generally does not form discrete drops before contacting the gelling agent in gelling vessel 320. Instead, semi-formed drops connected by thinner streams of material can contact the gelling agent. As described above, the gel-stabilized chains can be transferred from gelling vessel 320 to reactor vessel 330, where the polymer in the gel-stabilized chains is reacted (e.g., cross-linked), forming precursor particle chains. The precursor particle chains are transferred to gel dissolution chamber 340, where the gelling precursor is removed. The particle chains are then filtered in filter 350 to remove debris. Thereafter, the particle chains can be sterilized and packaged as an embolic composition including one or more of the particle chains.

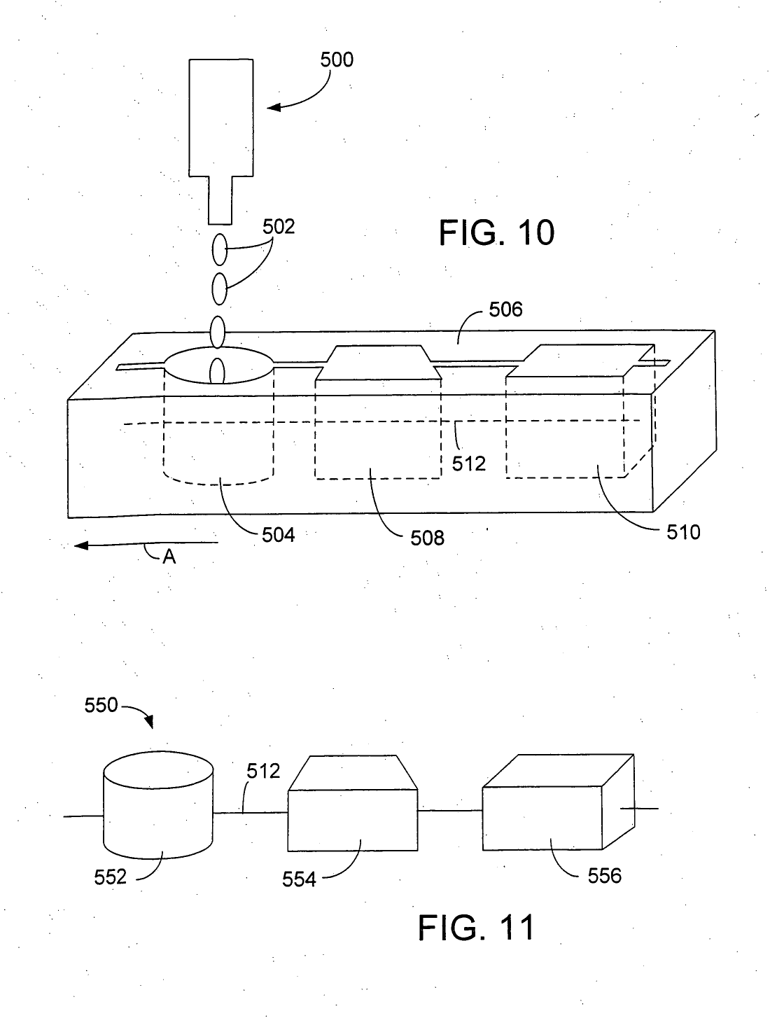

FIG. 10 shows another process for making particle chains. In FIG. 10, a drop generator 500 forms drops 502 (e.g., of a solution including a polyvinyl alcohol and alginate) which fall into a cavity 504 in a mold 506. Mold 506 also includes a cavity 508 and a cavity 510. Cavities 504, 508, and 510 are connected to each other by a continuous link 512. Mold 506 can be formed, for example, using MEMS machining. When cavity 504 is sufficiently filled with solution, mold 506 advances in the direction of arrow A, so that cavity 508 can be filled with solution. Thereafter, mold 506 again advances in the direction of arrow A, and cavity 510 is filled with solution. In certain embodiments, the cavity that is being filled is electrically charged so that drops 502 are drawn into the cavity. In some embodiments, after the cavities have been filled, a gelling agent (e.g., CaCl₂) can be added to the cavities (e.g., sprayed over the cavities) to solidify the solution in the cavities. In certain embodiments, mold 506 can be disposed in, for example, a tray containing a gelling agent, as drops 502 are falling into one or more of the cavities. Alternatively, mold 506 can be submerged in a gelling agent after drops 502 have filled one or more of the cavities. The final result of the cavity-filling process is particle chain 550, shown in FIG. 11, which includes particles 552, 554, and 556, connected by link 512. As particle chain 550 demonstrates, a particle chain can include particles of varying shapes.

In embodiments, particle chains can be formed by connecting particles to each other without using links. In some embodiments, a material (e.g., an adhesive) can be added to the surfaces of particles so that the particles attach to each other to form particle chains. In certain embodiments, the particles can have surface properties that cause the particles to stick to each other, forming particle chains.

In some embodiments, particle chains (e.g., particle chains that do not include links) can be formed by altering the conditions and/or parameters associated with the gelling process that occurs in gelling vessel 320. In some embodiments, the amount of time that the drops spend in gelling vessel 320 can be reduced to effect incomplete gel formation. In embodiments, substantially complete gel formation for drops with a diameter of from about 500 microns to about 700 microns can result from an exposure time of at least about five minutes, while incomplete gel formation can result from an exposure time of less than about five minutes (e.g., about three minutes). When gel formation is incomplete, the surfaces of the drops can be somewhat sticky and/or tacky, causing the drops to stick to each other when they come into contact with each other. Without wishing to be bound by theory, it is believed that a decrease in time spent by the drops in gelling vessel 320 can reduce the extent of cross-linking of the gelling precursor in the drops, thereby causing some of the sodium alginate in the drops to remain unreacted. The unreacted sodium alginate can cause the surfaces of the drops to be sticky and/or tacky. Alternatively or additionally, the concentration of gelling agent (e.g., calcium chloride) in gelling vessel 320 can be decreased to decrease the extent of cross-linking of the gelling precursor in the drops.

In certain embodiments, particle chains (e.g., particle chains that do not include links) can be formed by manipulating the formulation of the gelling precursor. For example, if the gelling precursor is sodium alginate, which includes both mannuronic acid blocks (“M blocks”) and guluronic acid blocks (“G blocks”), the extent of cross-linking of the sodium alginate in gelling vessel 320 can be affected by changing the ratio of M blocks to G blocks within the sodium alginate. As the concentration of G blocks increases, more cross-linking sites become available in the sodium alginate, so that the sodium alginate can gel more quickly within gelling vessel 320. By decreasing the concentration of G blocks within the sodium alginate, the degree of gelling within gelling vessel 320 can be decreased, as well.

In some embodiments, particle chains (e.g., particle chains that do not include links) can be formed by altering the conditions and/or parameters associated with the reaction step in reactor vessel 330. In certain embodiments, the temperature of the reaction step in reactor vessel 330 can be reduced (e.g., to about 40° C., to about 25° C.) to cause particle chains to form. In some embodiments, the ratio of drops to reaction solution in reactor vessel 330 can be increased to result in particle chain formation. In embodiments, the shape and/or size of reactor vessel 330 can be modified to increase the likelihood of particle chain formation. In general, as the size of reactor vessel 330 decreases, the likelihood of particle chain formation increases. In certain embodiments, the likelihood of particle chain formation can be increased by maintaining reactor vessel 330 in a relatively stationary state (e.g., by not agitating reactor vessel 330).

In embodiments, particle chains that have been formed by any of the above-described processes can be stabilized by removing the gel dissolution step from the process. Alternatively or additionally, particle chains can be stabilized by exposure to a reacting agent (e.g., an alkoxide such as an isopropoxide, a butoxide, an ethoxide, a propoxide) after the particle chains have been formed. The reacting agent can help to stabilize the particle chain configuration by further reacting with the polyvinyl alcohol.

As shown above with reference to FIGS. 2B and 2C, in some embodiments one or more particles chains 8 can be combined with a carrier fluid (e.g., a saline solution, a contrast agent, or both) to form an embolic composition. Such embolic compositions can be delivered to various sites in the body, including, for example, sites having cancerous lesions, such as the breast, prostate, lung, thyroid, or ovaries. The embolic compositions can be used in, for example, neural, pulmonary, and/or AAA (abdominal aortic aneurysm) applications. The compositions can be used in the treatment of, for example, fibroids, tumors, internal bleeding, arteriovenous malformations (AVMs), and/or hypervascular tumors. The compositions can be used as, for example, fillers for aneurysm sacs, AAA sac (Type II endoleaks), endoleak sealants, arterial sealants, and/or puncture sealants, and/or can be used to provide occlusion of other lumens such as fallopian tubes. Fibroids can include uterine fibroids which grow within the uterine wall (intramural type), on the outside of the uterus (subserosal type), inside the uterine cavity (submucosal type), between the layers of broad ligament supporting the uterus (interligamentous type), attached to another organ (parasitic type), or on a mushroom-like stalk (pedunculated type). Internal bleeding includes gastrointestinal, urinary, renal and varicose bleeding. AVMs are for example, abnormal collections of blood vessels, e.g. in the brain, which shunt blood from a high pressure artery to a low pressure vein, resulting in hypoxia and malnutrition of those regions from which the blood is diverted. In some embodiments, a composition containing the particle chain(s) can be used to prophylactically treat a condition.

The magnitude of a dose of an embolic composition can vary based on the nature, location and severity of the condition to be treated, as well as the route of administration. A physician treating the condition, disease or disorder can determine an effective amount of embolic composition. An effective amount of embolic composition refers to the amount sufficient to result in amelioration of symptoms or a prolongation of survival of the subject. The embolic compositions can be administered as pharmaceutically acceptable compositions to a subject in any therapeutically acceptable dosage, including those administered to a subject intravenously, subcutaneously, percutaneously, intratrachealy, intramuscularly, intramucosaly, intracutaneously, intra-articularly, orally or parenterally.

An embolic composition can include a mixture of particle chains (e.g., particle chains that include different types of therapeutic agents), or can include particle chains that are all of the same type. In some embodiments, an embolic composition can be prepared with a calibrated concentration of particle chains for ease of delivery by a physician. A physician can select an embolic composition of a particular concentration based on, for example, the type of embolization procedure to be performed. In certain embodiments, a physician can use an embolic composition with a relatively high concentration of particle chains during one part of an embolization procedure, and an embolic composition with a relatively low concentration of particle chains during another part of the embolization procedure.

Suspensions of particle chains in saline solution can be prepared to remain stable (e.g., to remain suspended in solution and not settle and/or float) over a desired period of time. A suspension of particle chains can be stable, for example, for from about one minute to about 20 minutes (e.g. from about one minute to about ten minutes, from about two minutes to about seven minutes, from about three minutes to about six minutes).

In some embodiments, particle chains can be suspended in a physiological solution by matching the density of the solution to the density of the particle chains. In certain embodiments, the particle chains and/or the physiological solution can have a density of from about one gram per cubic centimeter to about 1.5 grams per cubic centimeter (e.g., from about 1.2 grams per cubic centimeter to about 1.4 grams per cubic centimeter, from about 1.2 grams per cubic centimeter to about 1.3 grams per cubic centimeter).

The particle chains can be delivered (e.g., in an embolic composition) through a microcatheter, a syringe, and/or a catheter as discussed earlier. The size of the lumen of the syringe and/or the catheter can be larger than the particle diameter and/or the link width, to reduce compression of the particles and/or links during delivery. In embodiments in which the particles and/or links include an agent (e.g., a therapeutic agent), compression of the particles and/or links during delivery can eject the agent from the particles and/or links prematurely. While compression can result in release of agent, in some embodiments substantial release can be retarded under low compression force. In embodiments, the particles and/or links are compressed during delivery in order to use a delivery device that has a small diameter (e.g., to reduce patient trauma and/or more accurately position the particle chains about a lesion). The carrier fluid in which the particle chains are suspended can include agent so that, in embodiments in which the particles and/or the links have pores, the agent is drawn into the pores upon recovery to normal particle diameter and/or link width. For example, the particle chains can be delivered through a catheter having a lumen area that is smaller, e.g. 50 percent smaller or less, than the uncompressed cross-sectional area of the particles and/or links. The compression force is provided indirectly by increasing the pressure applied to the carrier fluid by pressing the syringe plunger. The particles and/or links are relatively easily compressed to diameters sufficient for delivery into the body. The robust, rigid surface region of the particles and/or links resists abrasion when the particles and/or links contact hard surfaces such as syringe surfaces, hard plastic or metal stopcock surfaces, and the catheter lumen wall (e.g. Teflon®) during delivery. Once in the body, the particles and/or links recover to their original diameter and/or width for efficient transport in the carrier and body fluid stream. At the point of occlusion, the particles and/or links can again compress as they aggregate in an occlusion region. The particles and/or links form a dense occluding mass. The compression in the body is limited and the number of particle chains needed to occlude a given diameter may be reduced. The particle chains can also be delivered directly into a tissue mass where re-expansion to larger particle diameters and/or link widths firmly lodges the particle chains into the tissue.

### EXAMPLES

The following examples are intended as illustrative and nonlimiting.

Three samples were prepared as follows, with the only variation in sample preparation being the duration of exposure to gelling solution (shown in Table 1).

An aqueous solution containing eight weight percent polyvinyl alcohol (99+ percent hydrolyzed, average M_{w} 89,000-120,000 (Aldrich)) and two weight percent sodium alginate (PRONOVA UPLVG, (FMC BioPolymer, Princeton, N.J.)) in deionized water was prepared.

The solution was filtered through a 105 micron filter (from Spectrum Laboratories Inc.), and was heated to about 65° C. Thereafter, 60 milliliters of the solution were added to each of four 60-cubic-centimer syringes.

Using a model PHD4400 syringe pump (Harvard Apparatus, Holliston, Mass.), the mixture was fed into a model NISCO Encapsulation unit VAR D drop generator (NISCO Engineering, Zurich, Switzerland) with a 200 micron nozzle, at a flow rate of about 5.4 milliliters per minute.

The jet stream of solution through the drop generator was broken up by a frequency of 0.56 KHz. The nozzle vibration amplitude was set at 95 percent of the maximum setting for the drop generator. The heating chamber of the drop generator was set at 65° C.

Drops generated by the drop generator were directed into a gelling vessel that was located about 5.5 inches below the nozzle orifice. The drops were collected in the gelling vessel for a period of about 11 minutes. The gelling vessel contained calcium chloride in deionized water, at room temperature (25° C.). The drops that fell into the gelling vessel were stirred with a stirring bar such that the calcium chloride solution and all of the drops in the solution were in motion.

After the drops had been exposed to the gelling vessel for a prescribed time, the calcium chloride solution was decanted.

Within about three minutes of decanting of the calcium chloride solution, the drops were added to a reaction vessel containing a solution of four weight percent formaldehyde (37 weight percent in methanol) and 20 weight percent sulfuric acid (95-98 percent concentrated).

The reaction solution was stirred at 200 revolutions per minute at 65° C. for about 20 minutes to form precursor particles or precursor particle chains. The reaction chemicals were then poured off the precursor particles and precursor particle chains.

The precursor particles and precursor particle chains were rinsed twice with deionized water (3×300 milliliters), each time for 15 minutes, to remove residual acidic solution. The reaction chemicals were then poured off the precursor particles and precursor particle chains.

The sodium alginate was substantially removed by soaking the precursor particles and precursor particle chains in a solution of five weight percent sodium hexa-methaphosphate in deionized water for 30 minutes, stirred at a speed of 150 revolutions per minute.

The solution was rinsed twice, each time for 30 minutes, in deionized water to remove residual phosphate and alginate.

The particles and particle chains were filtered by sieving first through a 1000 micron sieve, then through a 710 micron sieve, and finally through a 500 micron catch pan.

The three samples of particles that were produced are shown in Table I.

TABLE 1

| | Exposure | | | |
|---|---|---|---|---|
| | Time to | Size | | |
| | CaCl₂ | Distribution | Sphericity | Observations of Particles |
| Sample 1 | 3 minutes | 712.6 ± 168.2 | 0.96 ± 0.03 | White, sticky spheres that formed |
| | | microns | | aggregates |
| Sample 2 | 10 minutes | 630.6 ± 179.1 | 0.81 ± 0.17 | White, free-flowing spheres with a |
| | | microns | | large amount of debris |
| Sample 3 | 15 minutes | 544.8 ± 268.4 | 0.83 ± 0.13 | White, free-flowing spheres with a |
| | | microns | | large amount of debris |

Thus, the conditions for Sample 1 produced particle complexes, while the conditions for Samples 2 and 3 produced particles and debris.

While certain embodiments have been described, other embodiments are possible.

As an example, in some embodiments a particle or a link can include one or more therapeutic agents (e.g., drugs). The therapeutic agent(s) can be in and/or on particles 10. Alternatively or additionally, the therapeutic agent(s) can be in and/or on links 12. Particles 10 and/or links 12 can all include the same therapeutic agent or can include different therapeutic agents. Therapeutic agents include agents that are negatively charged, positively charged, amphoteric, or neutral. Therapeutic agents can be, for example, materials that are biologically active to treat physiological conditions; pharmaceutically active compounds; gene therapies; nucleic acids with and without carrier vectors; oligonucleotides; gene/vector systems; DNA chimeras; compacting agents (e.g., DNA compacting agents); viruses; polymers; hyaluronic acid; proteins (e.g., enzymes such as ribozymes); cells (of human origin, from an animal source, or genetically engineered); stem cells; immunologic species; nonsteroidal anti-inflammatory medications; oral contraceptives; progestins; gonadotrophin-releasing hormone agonists; chemotherapeutic agents; and radioactive species (e.g., radioisotopes, radioactive molecules). Non-limiting examples of therapeutic agents include anti-thrombogenic agents; antioxidants; angiogenic and anti-angiogenic agents and factors; anti-proliferative agents (e.g., agents capable of blocking smooth muscle cell proliferation); anti-inflammatory agents; calcium entry blockers; antineoplastic/antiproliferative/anti-mitotic agents (e.g., paclitaxel, doxorubicin, cisplatin); antimicrobials; anesthetic agents; anti-coagulants; vascular cell growth promoters; vascular cell growth inhibitors; cholesterol-lowering agents; vasodilating agents; agents which interfere with endogenous vasoactive mechanisms; and survival genes which protect against cell death. Therapeutic agents are described, for example, in co-pending U.S. patent application Ser. No. 10/615,276, filed on Jul. 8, 2003, and entitled “Agent Delivery Particle”, which is incorporated herein by reference.

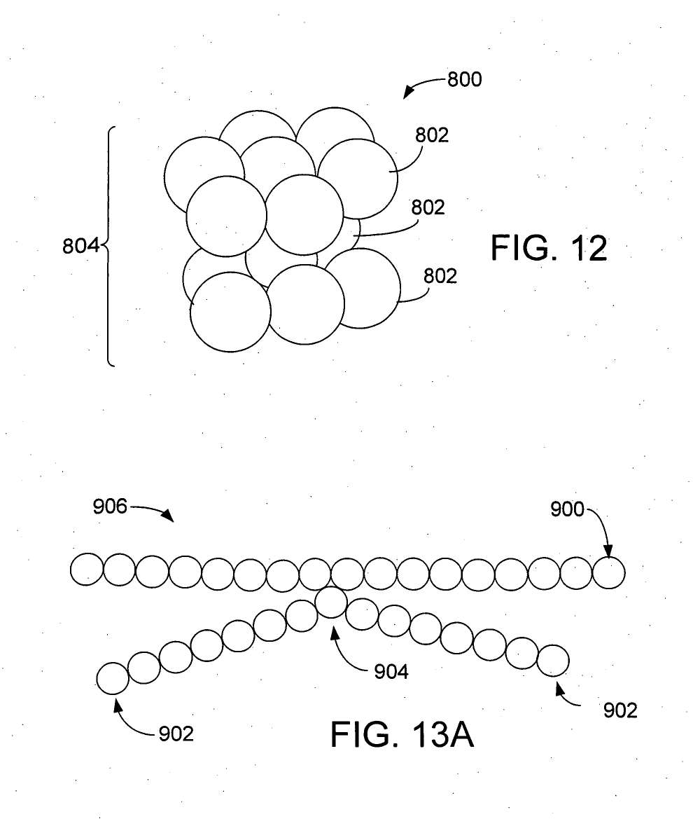

As another example, in some embodiments a particle chain can be non-linear (e.g., a particle chain can have a two-dimensional structure, a three-dimensional structure). For example, a particle chain can include groupings of particles that are attached to the particle chain along its length. In certain embodiments, a particle chain can be in the form of a ring, a plane, a sheet, a sphere, or another three-dimensional structure. For example, FIG. 12 shows a particle chain 800 including particles 802 that are closely bonded to each other to form a hexagonal close pack shape 804. In such embodiments, the particle chains can be delivered to a target site by one or more of the processes described above (e.g., using a catheter) and/or by surgical implantation.

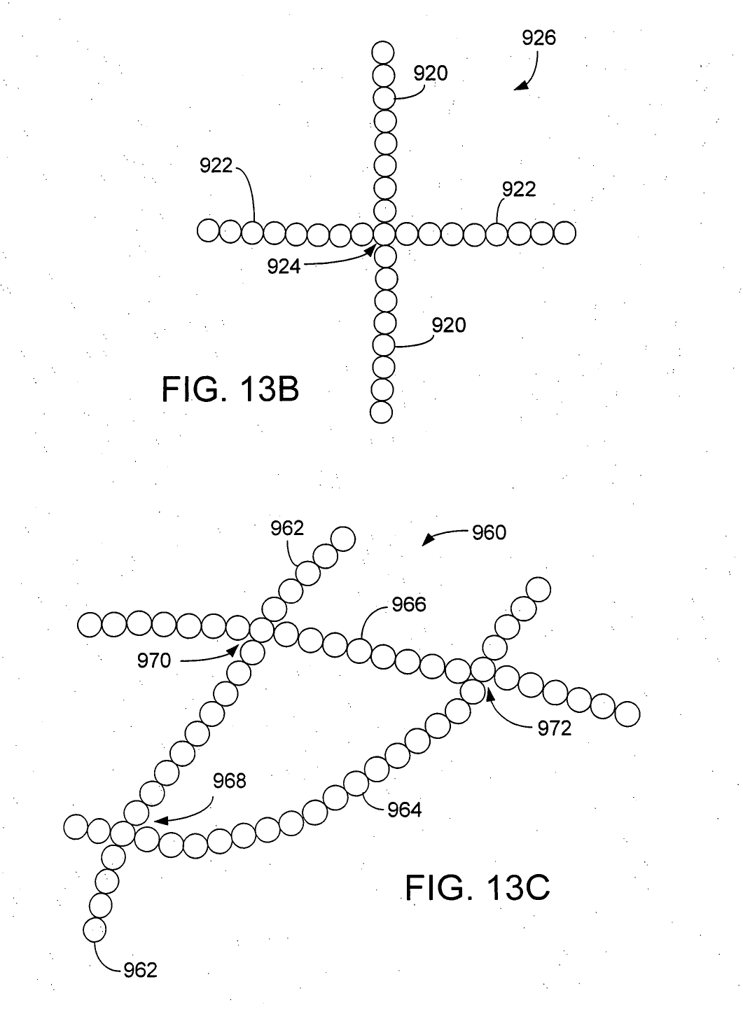

In certain embodiments, two or more particle chains can be connected to each other. For example, FIG. 13A shows a particle chain 900 that is connected to another particle chain 902 at a bonding point 904, forming a particle chain complex 906. Particle chains 900 and 902 can be the same as, or different from, each other. In some embodiments, and as shown in FIG. 13B, two particle chains 920 and 922 can intersect with each other at a point 924 to form a T-shaped particle chain complex 926. As FIG. 13C shows, in embodiments a particle chain complex 960 can be formed of three particle chains 962, 964, and 966 that intersect at multiple points 968, 970, and 972. Particle chain complexes can be formed of unions between two or more (e.g., three, four, five, six, seven, eight, nine, ten) particle chains.

As an additional example, in some embodiments a particle chain can be sized according to a particular application (e.g., chemembolization) and/or according to the size of a targeted location (e.g., the size of a targeted tumor). For example, a physician can select the appropriate size for a particle chain before or during a procedure. In certain embodiments, a link or particle in a particle chain can be severed, burned, and/or dissolved (e.g., with a chemical agent) to form a smaller particle chain. For example, a particle chain delivery device (e.g., a catheter) can include a means of disconnecting the particles in the particle chain (e.g., a cutter, a heater, a chemical agent), such that a particle chain can be sized upon delivery into, for example, body lumen.

As another example, in certain embodiments an embolic composition delivery device (e.g., a syringe and catheter) can be temporarily attached to one or more particle chains in an embolic composition. For example, a pusher wire or delivery wire in a catheter and/or syringe can be temporarily attached to a particle chain. Thus, as the particle chain is delivered (e.g., into a vessel), it can be partially or entirely withdrawn back into the catheter and/or syringe if necessary. The pusher can be detached from the particle chain by, for example, electrolytic or mechanical detachment.

As a further example, in some embodiments in which a particle chain is injected into a body lumen (e.g., to treat a cerebral aneurysm), an adhesive (e.g., a bioadhesive such as poly(ethylene oxide), carboxymethyl cellulose, or cyanoacrylate) can be injected with the particle chain. The adhesive can, for example, anchor the particle chain within a body lumen or 1 5 other targeted site.

As another example, particles 10 and/or links 12 can be bioerodible, such that they can eventually break down in the body and either be dispersed throughout the body or excreted from the body. For example, particles 10 and/or links 12 can be formed of a polysaccharide (such as an alginate); a polysaccharide derivative; an inorganic, ionic salt; a water soluble polymer (such as a polyvinyl alcohol, e.g., that has not been cross-linked); biodegradable poly DL-lactide-poly ethylene glycol (PELA); a hydrogel (e.g., polyacrylic acid, haluronic acid, gelatin, carboxymethyl cellulose); a polyethylene glycol (PEG); chitosan; a polyester (e.g., a polycaprolactone); a poly(lactic-co-glycolic) acid (e.g., a poly(d-lactic-co-glycolic) acid); or a combination thereof.

As an example, in some embodiments particles 10 and/or links 12 can be coated (e.g., with a bioabsorbable material). For example, particles 10 can be formed of a polyvinyl alcohol and can include a sodium alginate coating. The coating can contain, for example, one or more therapeutic agents, or can be substantially free of therapeutic agents. In certain embodiments, the particles and/or links can be coated to include a high concentration of one or more therapeutic agents that can alternatively or additionally be loaded into the interior of the particles and/or links. The coating can release an initial dosage of therapeutic agent after which the bodies of the particles and/or links can provide a burst release of therapeutic agent. The therapeutic agent in the coating can be the same as or different from the therapeutic agent in the bodies of the particles and/or links. The therapeutic agent in the coating can be applied, for example, by exposing the particles and/or links to a high concentration solution of the therapeutic agent. Coatings are described, for example, in U.S. patent application Ser. No. 10/615,276, filed on Jul. 8, 2003, and entitled “Agent Delivery Particle”, which is incorporated herein by reference.

In some embodiments, the coating can be, for example, a degradable and/or bioabsorbable polymer which erodes when the particle chain is administered. The coating can assist in controlling the rate at which therapeutic agent is released from the particles and/or links. For example, the coating can be in the form of a porous membrane. The coating can delay an initial burst of therapeutic agent release. The coating can be applied by dipping or spraying the particles and/or links. The erodible polymer can be a polysaccharide (such as an alginate) or a polysaccharide derivative. In certain embodiments, the coating can be an inorganic, ionic salt. Other erodible coatings include water soluble polymers (such as a polyvinyl alcohol, e.g., that has not been cross-linked), biodegradable poly DL-lactide-poly ethylene glycol (PELA), hydrogels (e.g., polyacrylic acid, haluronic acid, gelatin, carboxymethyl cellulose), polyethylene glycols (PEG), chitosan, polyesters (e.g., polycaprolactones), and poly(lactic-co-glycolic) acids (e.g., poly(d-lactic-co-glycolic) acids). A polymer coating, e.g. an erodible coating, can be applied to the surfaces of the particles and/or links in cases in which a high concentration of therapeutic agent has not been applied to the surfaces of the particles and/or links.

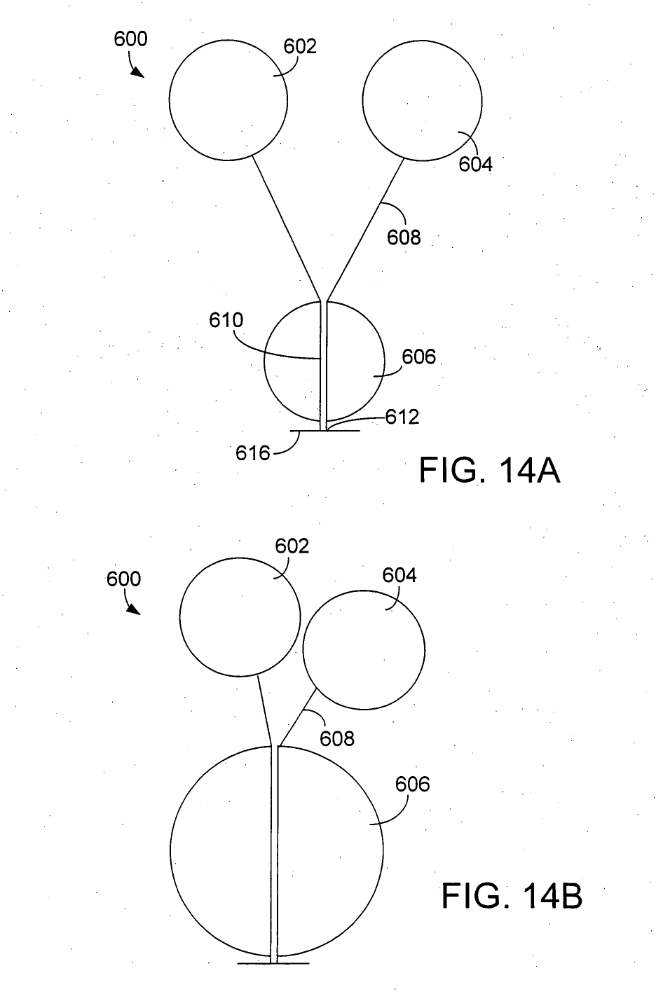

As a further example, in some embodiments one or more of the particles and/or links in a particle chain can include a super-absorbable polymer and/or a shape-memory material (e.g., a polymer). Examples of super-absorbable polymers include Merocel® polymer. Examples of shape-memory materials include nitinol. Shape memory materials and particles that include shape memory materials are described in, for example, U.S. patent application Ser. No. 10/700,970, filed Nov. 4, 2003, and entitled “Embolic Compositions”, and U.S. patent application Ser. No. 10/791,103, filed Mar. 2, 2004, and entitled “Embolic Compositions”, both of which are incorporated herein by reference. FIG. 14A shows a particle chain 600 that includes particles 602 and 604, and a particle 606 that is formed of a super-absorbable polymer. Particles 602, 604, and 606 are connected to each other by a continuous link 608, which can be formed of the same materials as link 12, and/or can be formed of the same materials as particle 602, 604, and/or 606. Link 608 forms a loop 610 within particle 606. End 612 of loop 610 protrudes through particle 606, and is attached to a rod 616 that prevents loop 610 from slipping out of particle 606. As shown in FIG. 14B, when particle 606 expands (e.g., in response to a change in pH and/or temperature, and/or upon exposure to blood), particle 606 consumes more of link 608, thereby bringing particles 602 and 604 closer to particle 606 and to each other. As a result, particle chain 600 can, for example, occlude a body lumen. In some embodiments, particle 606 is coated with a bioerodible material that erodes during and/or after delivery to expose the super-absorbable polymer so that particle 606 does not expand prematurely.

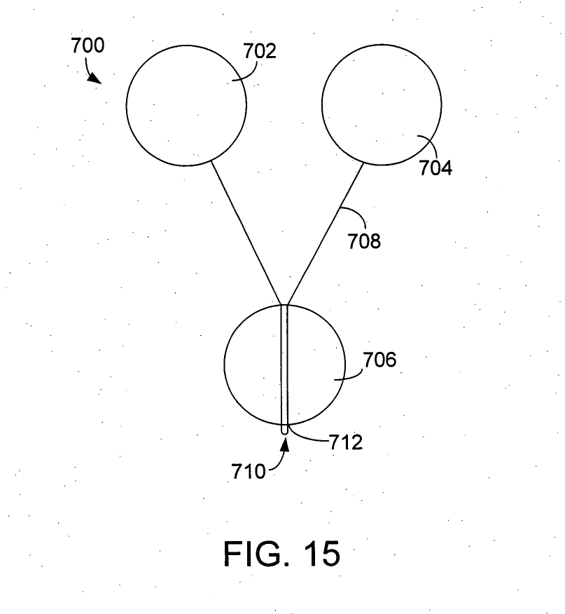

In some embodiments, and as shown in FIG. 15, a particle chain 700 can include three particles 702, 704, and 706, connected by a link 708 that loops through the interior of particle 706. Link 708 forms a stitch 710 on the outer surface 712 of particle 706, thereby securing its position within particle 706. Particle chain 700 can function, for example, similarly to particle chain 600, described with reference to FIGS. 14A and 14B above.

As an additional example, in some embodiments one or more particles is/are substantially nonspherical. As noted above, in certain embodiments, a particle chain can include particles of different shapes (e.g., cubic, spherical, cylindrical). In some embodiments, particles can be shaped (e.g., molded, compressed, punched, and/or agglomerated with other particles) at different points in the particle manufacturing process. In certain embodiments (e.g., where the base polymer is a polyvinyl alcohol, and the gelling precursor is sodium alginate), after contacting the particles with the gelling agent but before cross-linking, the particles can be physically deformed into a specific shape and/or size. After shaping, the base polymer (e.g., a polyvinyl alcohol) can be cross-linked, optionally followed by substantial removal of the gelling precursor (e.g., alginate). While substantially spherical particles are preferred, non-spherical particles can be manufactured and formed by controlling, for example, drop formation conditions. In some embodiments, nonspherical particles can be formed by post-processing the particles (e.g., by cutting or dicing into other shapes). Particle shaping is described, for example, in co-pending U.S. patent application Ser. No. 10/402,068, filed Mar. 28, 2003, and entitled “Forming a Chemically Cross-Linked Particle of a Desired Shape and Diameter”, which is incorporated herein by reference.

As a further example, in some embodiments, different particle chains (e.g., particle chains including particles with different shapes, sizes, physical properties, and/or chemical properties) can be used together in an embolization procedure. The different particle chains can be delivered into the body of a subject in a predetermined sequence or simultaneously. In certain embodiments, mixtures of different particle chains can be delivered using a multi-lumen catheter and/or syringe. In some embodiments, different particle chains can be capable of interacting synergistically (e.g., by engaging or interlocking) to form a well-packed occlusion, thereby enhancing embolization. Particles with different shapes, sizes, physical properties, and/or chemical properties, and methods of embolization using such particles are described, for example, in U.S. patent application Ser. No. 10/700,970, filed Nov. 4, 2003, and entitled “Embolic Compositions”, and in U.S. patent application Ser. No. 10/791,103, filed Mar. 2, 2004, and entitled “Embolic Compositions”, both of which are incorporated herein by reference.

As a further example, in some embodiments the particle chains can be used for tissue bulking. As an example, the particle chains can be placed (e.g., injected) into tissue adjacent to a body passageway. The particle chains can narrow the passageway, thereby providing bulk and allowing the tissue to constrict the passageway more easily. The particle chains can be placed in the tissue according to a number of different methods, for example, percutaneously, laparoscopically, and/or through a catheter. In certain embodiments, a cavity can be formed in the tissue, and the particle chains can be placed in the cavity. Particle chain tissue bulking can be used to treat, for example, intrinsic sphincteric deficiency (ISD), vesicoureteral reflux, gastroesophageal reflux disease (GERD), and/or vocal cord paralysis (e.g., to restore glottic competence in cases of paralytic dysphonia). In some embodiments, particle chain tissue bulking can be used to treat urinary incontinence and/or fecal incontinence. The particle chains can be used as a graft material or a filler to fill and/or to smooth out soft tissue defects, such as for reconstructive or cosmetic applications (e.g., surgery). Examples of soft tissue defect applications include cleft lips, scars (e.g., depressed scars from chicken pox or acne scars), indentations resulting from liposuction, wrinkles (e.g., glabella frown wrinkles), and soft tissue augmentation of thin lips. Tissue bulking is described, for example, in co-pending U.S. patent application Ser. No. 10/231,664, filed on Aug. 30, 2002, and entitled “Tissue Treatment”, which is incorporated herein by reference.

As another example, the particles and/or links in a particle chain can be prepared (e.g., for use in an embolic composition) without removal of the gelling precursor (e.g., alginate). Such particles and/or links can be prepared, for example, using a drop generator as described above, but without removing the gelling precursor from the particles and/or links after cross-linking.

As another example, the particles and/or links can include other materials. For example, in some embodiments, the particles and/or links can include (e.g., encapsulate) diagnostic agent(s) such as a radiopaque material, a material that is visible by magnetic resonance imaging (an MRI-visible material), a ferromagnetic material, and/or an ultrasound contrast agent. Diagnostic agents are described in U.S. patent application Ser. No. 10/651,475, filed on Aug. 29, 2003, and entitled “Embolization”, which is incorporated herein by reference. In certain embodiments, the particles and/or links can include a surface preferential material. Surface preferential materials are described, for example, in U.S. patent application Ser. No. 10/791,552, filed on Mar. 2, 2004, and entitled “Embolization”, which is incorporated herein by reference.

As an example, the links can include pores.

As another example, in some embodiments, some or all of the links in a particle chain can have a non-circular (e.g., triangular, square) cross-section.

As a further example, in some embodiments a particle can be formed without pores (nonporous particle).

As an additional example, in some embodiments a particle can be substantially non-compressible.

Other embodiments are in the claims.

1. A composition, comprising:
a particle chain having at least two connected particles, wherein at least one of the at least two connected particles has an interior region with a density of large pores and a surface region with a density of large pores, and the density of large pores of the interior region is greater than the density of large pores at the surface region.

2. The composition of claim 1, wherein each of the at least two connected particles has a diameter of from about ten microns to about 3,000 microns.

3. The composition of claim 1, wherein the particle chain has a restrained length of at most about 50 centimeters.

4. The composition of claim 1, wherein the particle chain has a restrained length of at least about one centimeter.

5. The composition of claim 1, wherein the at least two connected particles are connected by a link.

6. The composition of claim 1, wherein the at least two connected particles are connected by a link having a length of at most about 50,000 microns.

7. The composition of claim 1, wherein the at least two connected particles are connected by a link having a length of at least about one micron.

8. The composition of claim 1, wherein the at least two connected particles are connected by a link having a width of at most about 0.01 inch.

9. The composition of claim 1, wherein the at least two connected particles are connected by a link having a width of at least 0.001 inch.

10. The composition of claim 1, wherein the at least two connected particles are connected by a link having an aspect ratio of at most about 1,000.

11. The composition of claim 1, wherein the at least two connected particles are connected by a link having an aspect ratio of at most 25.

12. The composition of claim 1, wherein the at least two connected particles are connected by a link having an aspect ratio of at least 0.001.

13. The composition of claim 1, wherein the at least two connected particles are connected by a link and a ratio of the diameter of one of the at least two particles to a width of the link is at most about 100.

14. The composition of claim 1, wherein the at least two connected particles are connected by a link and a ratio of the diameter of one of the at least two particles to a width of the link is at least about 0.5.

15. The composition of claim 1, wherein the at least two connected particles are connected by a link comprising a polymer or a metal.

16. The composition of claim 1, wherein the at least two connected particles are connected by a link comprising a fiber.

17. The composition of claim 1, wherein the at least two connected particles are connected by a link comprising a material that is different from a material of at least one of the particles.

18. The composition of claim 1, wherein the at least two connected particles are connected by a link and the link is integrally formed with at least one of the particles.

19. The composition of claim 1, wherein the at least two connected particles are connected by a link and the link is attached to at least one of the particles.

20. The composition of claim 1, wherein the at least two connected particles are connected by a polymer link that is grafted to the particles.

21. The composition of claim 1, wherein the at least two connected particles include a first particle comprising a first polymer and a second particle comprising a second polymer, and the first polymer is the same as the second polymer.

22. The composition of claim 1, wherein the at least two connected particles include a first particle comprising a first polymer and a second particle comprising a second polymer, and the first polymer is different from the second polymer.

23. The composition of claim 1, wherein the at least two connected particles comprise first and second particles, and a diameter of the first particle is the same as a diameter of the second particle.

24. The composition of claim 1, wherein the at least two connected particles comprise first and second particles, and a diameter of the first particle is different from a diameter of the second particle.

25. The composition of claim 1, wherein the composition further comprises a carrier fluid.

26. The composition of claim 25, wherein the carrier fluid comprises a saline solution.

27. The composition of claim 25, wherein the carrier fluid comprises a contrast agent.

28. The composition of claim 25, wherein the at least two connected particles have an arithmetic mean diameter of about 3,000 microns or less.

29. The composition of claim 25, wherein the at least two connected particles have an arithmetic mean diameter of about ten microns or more.

30. The composition of claim 1, wherein the particle chain has a two-dimensional structure.

31. The composition of claim 1, wherein the particle chain has a three-dimensional structure.

32. A method, comprising:
forming a mixture containing a polymer and a gelling compound; and
treating the mixture to form a particle chain including at least two connected particles, wherein at least one of the at least two connected particles has an interior region with a density of large pores and a surface region with a density of large pores, and the density of large pores of the interior region is greater than the density of large pores at the surface region.

33. The method of claim 32, further comprising forming drops of the mixture.

34. The method of claim 33, further comprising contacting the drops with a gelling agent.

35. The method of claim 34, further comprising reacting the polymer.

36. The method of claim 35, further comprising removing the gelling compound.

37. The method of claim 32, further comprising combining the particles with a pharmaceutically acceptable medium.

38. The method of claim 32, further comprising grafting a second polymer to the at least two particles to form a link between the particles.

39. The method of claim 32, further comprising forming a stream of the mixture and treating the stream with a gelling agent.

40. The method of claim 32, further comprising forming a laminar stream of the mixture and exposing the stream to a non-uniform frequency.

41. A method, comprising:
administering to a patient a therapeutically effective amount of a composition comprising a particle chain having at least two connected particles, wherein at least one of the at least two connected particles has an interior region with a density of large pores and a surface region with a density of large pores, and the density of large pores of the interior region is greater than the density of large pores at the surface region.

42. The method of claim 41, wherein the method of administration is by percutaneous injection.

43. The method of claim 41, wherein the method includes embolizing a body lumen.

44. The method of claim 41, wherein the method includes embolizing a body lumen associated with a cancer condition.

45. A method of forming a particle chain having at least two linked particles, the method comprising:
forming the at least two particles in at least two particle cavities in a mold; and
forming a link between the at least two particles in a link cavity in the mold that connects the at least two particle cavities, to form the particle chain.

46. A method of forming a particle chain having at least two linked particles, the method comprising:
disposing a filament of material through at least two cavities in a mold; and
forming the at least two particles in the cavities so that the at least two particles are linked by the filament to form the particle chain.

47. A composition, comprising:
a particle chain having at least two adjacent particles that are connected by a filament, wherein at least one of the at least two adjacent particles comprises a polymer that can change shape to change the length of the filament between the at least two adjacent particles.

48. The composition of claim 47, wherein at least one of the at least two adjacent particles comprises a shape-memory material or a superabsorbable polymer.
